(19) United States
(12) Patent Application Publication
(10) Pub. No.: US 2022/0060702 A1
(43) Pub. Date: Feb. 24, 2022

(54) SYSTEMS AND METHODS FOR INTRA PREDICTION SMOOTHING FILTER

(71) Applicant: ALIBABA GROUP HOLDING LIMITED, George Town (KY)

(72) Inventors: Xinwei LI, San Mateo, CA (US); Jie CHEN, San Mateo, CA (US); Ruling LIAO, San Mateo, CA (US); Yan YE, San Mateo, CA (US)

(21) Appl. No.: 17/401,811

(22) Filed: Aug. 13, 2021

Related U.S. Application Data
(60) Provisional application No. 63/068,504, filed on Aug. 21, 2020.
(60) Provisional application No. 63/091,331, filed on Oct. 14, 2020.

(51) Int. Cl. H04N 19/117; H04N 19/82; H04N 19/105; H04N 19/132; H04N 19/159; H04N 19/46; H04N 19/176

(52) U.S. Cl. CPC H04N 19/117; H04N 19/82; H04N 19/105; H04N 19/176; H04N 19/159; H04N 19/46; H04N 19/132

(57) ABSTRACT

The present disclosure provides methods, apparatus and non-transitory computer readable medium for video processing. According to certain disclosed embodiments, A method for video processing includes: dividing an intra prediction block into one or more sub-blocks; performing padding process for the one or more sub-blocks; and filtering the one or more sub-blocks with a parallel intra prediction smoothing (IPS) process.

### CROSS-REFERENCE TO RELATED APPLICATIONS

The disclosure claims the benefits of priority to U.S. Provisional Application No. 63/068,504, filed on Aug. 21, 2020, and U.S. Provisional Application No. 63/091,331, filed on Oct. 14, 2020, both of which are incorporated herein by reference in their entireties.

### TECHNICAL FIELD

The present disclosure generally relates to video processing, and more particularly, to systems and methods for intra prediction smoothing (IPS) filter.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (HEVC/H.265) standard, the Versatile Video Coding (VVC/H.266) standard, and AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

Embodiments of the present disclosure provide a video processing method. The method includes: dividing an intra prediction block into one or more sub-blocks; performing padding process for the one or more sub-blocks; and filtering the one or more sub-blocks with a parallel intra prediction smoothing (IPS) process.

Embodiments of the present disclosure provide an apparatus for video processing, the apparatus including: a memory figured to store instructions; and one or more processors configured to execute the instructions to cause the apparatus to perform: dividing an intra prediction block into one or more sub-blocks; performing padding process for the one or more sub-blocks; and filtering the one or more sub-blocks with a parallel intra prediction smoothing (IPS) process.

Embodiments of the present disclosure provide a non-transitory computer-readable storage medium that stores a set of instructions that is executable by one or more processors of an apparatus to cause the apparatus to initiate a method for video processing, the method includes: dividing an intra prediction block into one or more sub-blocks; performing padding process for the one or more sub-blocks; and filtering the one or more sub-blocks with a parallel intra prediction smoothing (IPS) process.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating structures of an example video sequence, according to some embodiments of the present disclosure.

FIG. 2A is a schematic diagram illustrating an exemplary encoding process of a hybrid video coding system, consistent with embodiments of the disclosure.

FIG. 2B is a schematic diagram illustrating another exemplary encoding process of a hybrid video coding system, consistent with embodiments of the disclosure.

FIG. 3A is a schematic diagram illustrating an exemplary decoding process of a hybrid video coding system, consistent with embodiments of the disclosure.

FIG. 3B is a schematic diagram illustrating another exemplary decoding process of a hybrid video coding system, consistent with embodiments of the disclosure.

FIG. 4 is a block diagram of an exemplary apparatus for encoding or decoding a video, according to some embodiments of the present disclosure.

FIG. 5 is a schematic diagram illustrating an exemplary intra prediction smoothing (IPS) padding process, according to some embodiments of the present disclosure.

FIG. 6 is a schematic diagram illustrating an exemplary 13-tap filter, according to some embodiments of the present disclosure.

FIG. 7 is a schematic diagram illustrating an exemplary 25-tap filter, according to some embodiments of the present disclosure.

FIG. 8 is a schematic diagram illustrating another exemplary 13-tap filter, according to some embodiments of the present disclosure.

FIG. 9 shows an exemplary of positions of the samples used in an 9+4 tap filter, according to some embodiments of the present disclosure.

FIG. 10 is a schematic diagram illustrating exemplary intra prediction reference samples, according to some embodiments of the present disclosure.

FIG. 11 illustrates different prediction modes in intra prediction, according to some embodiments of the present disclosure.

FIG. 12 is a schematic diagram illustrating an exemplary prediction of bilinear mode, according to some embodiments of the present disclosure.

FIG. 13 is a schematic diagram illustrating an exemplary prediction of angular mode, according to some embodiments of the present disclosure.

FIG. 14 is an exemplary look up table for inter prediction filter (interPF), according to some embodiments of the present disclosure.

FIG. 15 is a schematic diagram illustrating an exemplary IPS process for sample, according to some embodiments of the present disclosure.

FIG. 16 illustrates a flow-chart of an exemplary method for improving intra prediction smoothing (IPS), according to some embodiments of the present disclosure.

FIG. 17A illustrates a flow-chart of an exemplary method for dividing a M×H sub-block to perform the IPS, according to some embodiments of the present disclosure.

FIG. 17B is a schematic diagram illustrating an exemplary IPS process for sample X in a sub-block, according to some embodiments of the present disclosure.

FIG. 18 illustrates a flow-chart of an exemplary method for dividing a W×N sub-block to perform the IPS, according to some embodiments of the present disclosure.

FIG. 19 illustrates a flow-chart of an exemplary method for dividing a M×N sub-block to perform the IPS, according to some embodiments of the present disclosure.

FIGS. 20A and 20B illustrate exemplary vertical splitting and horizontal splitting of a prediction block respectively, according to some embodiments of the present disclosure.

FIG. 21 illustrates an exemplary padding process for a sub-block, according to some embodiments of the present disclosure.

FIGS. 22A-22C illustrate another exemplary padding process for sub-block, according to some embodiments of the present disclosure.

FIG. 23 illustrates another exemplary padding process for sub-block, according to some embodiments of the present disclosure.

FIG. 24 is an exemplary 25-tap filter, according to some embodiments of the present disclosure.

FIG. 25A illustrates an exemplary 9-tap filter, according to some embodiments of the present disclosure.

FIG. 25B illustrates another exemplary 9-tap one-side filter, according to some embodiments of the present disclosure.

FIG. 26A illustrates an exemplary 6-tap one-side filter, according to some embodiments of the present disclosure.

FIG. 26B illustrates another exemplary 6-tap one-side filter, according to some embodiments of the present disclosure.

FIG. 27 illustrate an exemplary 81-tap filter, according to some embodiments of the present disclosure.

FIG. 28A illustrate an exemplary 25-tap filter, according to some embodiments of the present disclosure.

FIG. 28B illustrates another exemplary 25-tap one-side filter, according to some embodiments of the present disclosure.

FIG. 29 illustrates a flow-chart of an exemplary method for improving IPS, according to some embodiments of the present disclosure.

FIGS. 30A-30D illustrate exemplary cropped filters, according to some embodiments of the present disclosure.

FIG. 31A illustrates an exemplary horizontal one-dimensional (1D) 5-tap filter, according to some embodiments of the present disclosure.

FIG. 31B illustrates an exemplary vertical 1D 5-tap filter, according to some embodiments of the present disclosure.

FIG. 32A illustrates another exemplary horizontal 1D 5-tap filter, according to some embodiments of the present disclosure.

FIG. 32B illustrates another exemplary vertical 1D 5-tap filter, according to some embodiments of the present disclosure.

FIGS. 33A and 33B illustrate another exemplary two 1D 5-tap filters, according to some embodiment of the present disclosure.

FIG. 34A illustrates a first exemplary flow-chart for the selection of the filters, according to some embodiments of the present disclosure.

FIG. 34B illustrates a second exemplary flow-chart for the selection of the filters, according to some embodiments of the present disclosure.

FIG. 34C illustrates a third exemplary flow-chart for the selection of the filters, according to some embodiments of the present disclosure.

FIG. 34D illustrates a fourth exemplary flow-chart for the selection of the filters, according to some embodiments of the present disclosure.

FIG. 35 illustrates an exemplary 5+4 tap filter, according to some embodiments of the present disclosure.

FIG. 36 illustrates an exemplary 5+6 tap filter, according to some embodiments of the present disclosure.

FIG. 37 illustrates an exemplary 3+4 tap filter, according to some embodiments of the present disclosure.

FIG. 38A illustrates an exemplary 5+2 tap filter, according to some embodiments of the present disclosure.

FIG. 38B illustrates an exemplary 5+3 tap filter, according to some embodiments of the present disclosure.

FIG. 39 illustrates another exemplary 5+2 tap filter, according to some embodiments of the present disclosure.

FIG. 40 illustrates another exemplary 5+2 tap filter, according to some embodiments of the present disclosure.

FIG. 41 is a schematic diagram illustrating an exemplary intra prediction filtering with reference samples, according to some embodiments of the present disclosure.

FIGS. 42A-42C illustrate exemplary intra prediction filtering with reference samples in different directions, according to some embodiments of the present disclosure.

FIG. 43 illustrates a flow-chart of an exemplary method for improving IPS, according to some embodiments of the present disclosure.

FIG. 44A illustrates an exemplary flow-chart for selection of the filters, according to some embodiments of the present disclosure.

FIG. 44B illustrates another exemplary flow-chart for selection of the filters, according to some embodiments of the present disclosure.

FIG. 44C illustrates another exemplary flow-chart for selection of the filters, according to some embodiments of the present disclosure.

FIG. 45 is a schematic diagram illustrating an exemplary coding flow of TSCPM, according to some embodiments of the present disclosure.

FIG. 46A illustrates exemplary selected samples for deriving the model parameters for TSCPM_T and PMC_T modes, according to some embodiments of the present disclosure.

FIG. 46B illustrates exemplary selected samples for deriving the model parameters for TSCPM_L and PMC_L modes, according to some embodiments of the present disclosure.

FIG. 47 illustrates a flow-chart of an exemplary method for selecting samples for deriving model parameters, according to some embodiments of the present disclosure.

FIGS. 48A and 48B illustrate exemplary selected samples for deriving the model parameters, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The Joint Video Experts Team (WET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve the same subjective quality as HEVC/H.265 using half the bandwidth, the JVET has been developing technologies beyond HEVC using the joint exploration model (JEM) reference software. As coding technologies were incorporated into the JEM, the JEM achieved substantially higher coding performance than HEVC.

The VVC standard has been developed recent, and continues to include more coding technologies that provide better compression performance. VVC is based on the same hybrid video coding system that has been used in modern video compression standards such as HEVC, H.264/AVC, MPEG2, H.263, etc.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) include changes with respect to a reference picture (e.g., a picture previously encoded and reconstructed). Such changes can include position changes, luminosity changes, or color changes of the samples, among which the position changes are mostly concerned. Position changes of a group of samples that represent an object can reflect the motion of the object between the reference picture and the current picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., uni-prediction). A picture is referred to as a “B-picture” if at least one block in it is predicted with two reference pictures (e.g., bi-prediction).

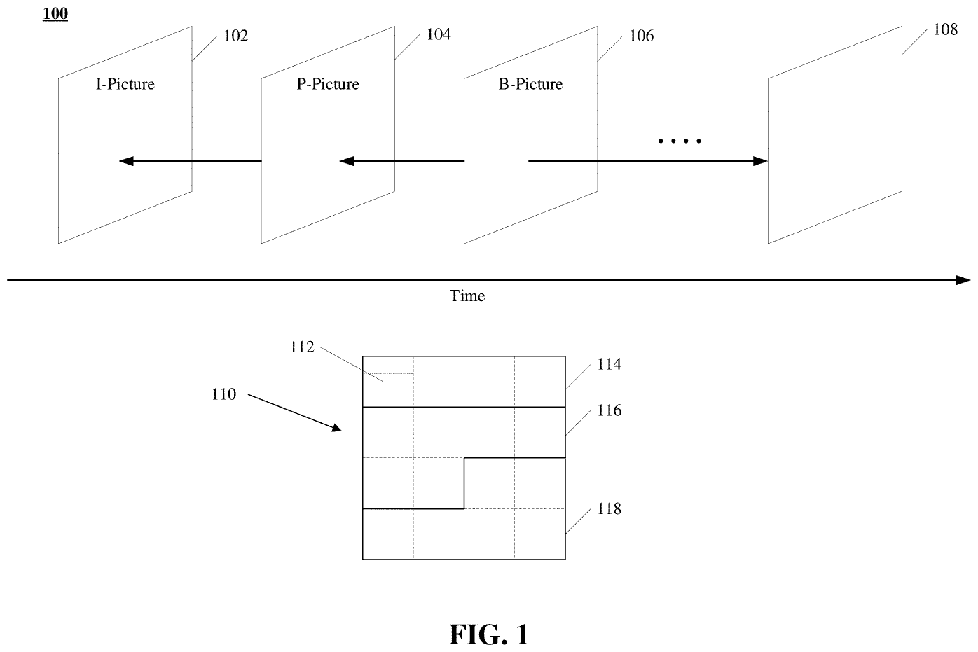

FIG. 1 illustrates structures of an example video sequence 100, according to some embodiments of the present disclosure. Video sequence 100 can be a live video or a video having been captured and archived. Video 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 1, video sequence 100 can include a series of pictures arranged temporally along a timeline, including pictures 102, 104, 106, and 108. Pictures 102-106 are continuous, and there are more pictures between pictures 106 and 108. In FIG. 1, picture 102 is an I-picture, the reference picture of which is picture 102 itself. Picture 104 is a P-picture, the reference picture of which is picture 102, as indicated by the arrow. Picture 106 is a B-picture, the reference pictures of which are pictures 104 and 108, as indicated by the arrows. In some embodiments, the reference picture of a picture (e.g., picture 104) can be not immediately preceding or following the picture. For example, the reference picture of picture 104 can be a picture preceding picture 102. It should be noted that the reference pictures of pictures 102-106 are only examples, and the present disclosure does not limit embodiments of the reference pictures as the examples shown in FIG. 1.

Typically, video codecs do not encode or decode an entire picture at one time due to the computing complexity of such tasks. Rather, they can split the picture into basic segments, and encode or decode the picture segment by segment. Such basic segments are referred to as basic processing units (“BPUs”) in the present disclosure. For example, structure 110 in FIG. 1 shows an example structure of a picture of video sequence 100 (e.g., any of pictures 102-108). In structure 110, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC or H.266/VVC). The basic processing units can have variable sizes in a picture, such as 128×128, 64×64, 32×32, 16×16, 4×8, 16×32, or any arbitrary shape and size of samples. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC or H.266/VVC). Any operation performed to a basic processing unit can be repeatedly performed to each of its luma and chroma components.

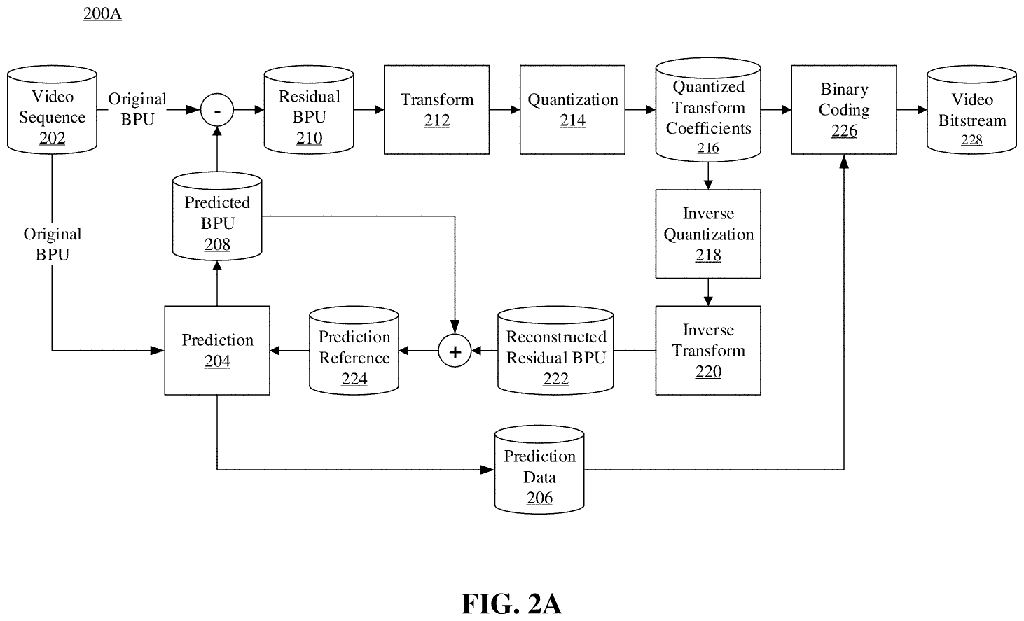

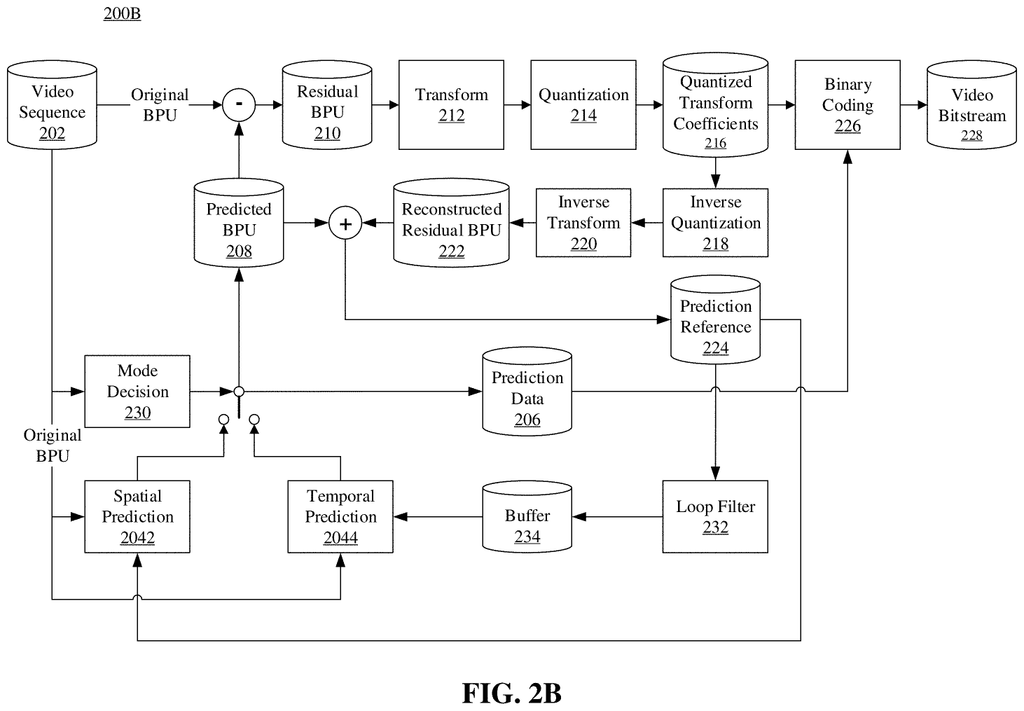

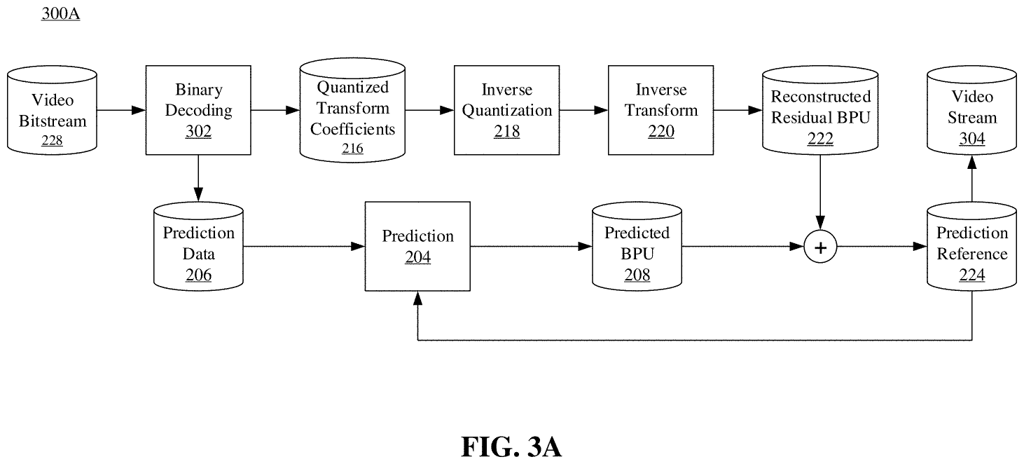

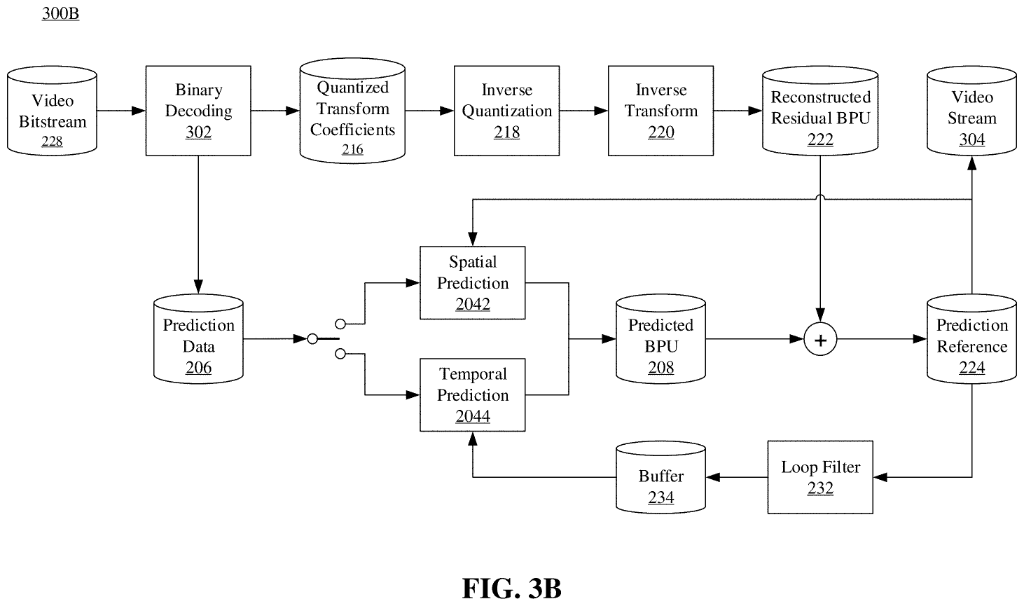

Video coding has multiple stages of operations, examples of which are shown in FIGS. 2A-2B and FIGS. 3A-3B. For each stage, the size of the basic processing units can still be too large for processing, and thus can be further divided into segments referred to as “basic processing sub-units” in the present disclosure. In some embodiments, the basic processing sub-units can be referred to as “blocks” in some video coding standards (e.g., MPEG family, H.261, H.263, or H.264/AVC), or as “coding units” (“CUs”) in some other video coding standards (e.g., H.265/HEVC or H.266/VVC). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed to a basic processing sub-unit can be repeatedly performed to each of its luma and chroma components. It should be noted that such division can be performed to further levels depending on processing needs. It should also be noted that different stages can divide the basic processing units using different schemes.

For example, at a mode decision stage (an example of which is shown in FIG. 2B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC or H.266/VVC), and decide a prediction type for each individual basic processing sub-unit.

For another example, at a prediction stage (an example of which is shown in FIGS. 2A-2B), the encoder can perform prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/HEVC or H.266/VVC), at the level of which the prediction operation can be performed.

For another example, at a transform stage (an example of which is shown in FIGS. 2A-2B), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/HEVC or H.266/VVC), at the level of which the transform operation can be performed. It should be noted that the division schemes of the same basic processing sub-unit can be different at the prediction stage and the transform stage. For example, in H.265/HEVC or H.266/VVC, the prediction blocks and transform blocks of the same CU can have different sizes and numbers.

In structure 110 of FIG. 1, basic processing unit 112 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC and H.266/VVC provide two types of regions: “slices” and “tiles.” It should also be noted that different pictures of video sequence 100 can have different partition schemes for dividing a picture into regions.

For example, in FIG. 1, structure 110 is divided into three regions 114, 116, and 118, the boundaries of which are shown as solid lines inside structure 110. Region 114 includes four basic processing units. Each of regions 116 and 118 includes six basic processing units. It should be noted that the basic processing units, basic processing sub-units, and regions of structure 110 in FIG. 1 are only examples, and the present disclosure does not limit embodiments thereof.

FIG. 2A illustrates a schematic diagram of an example encoding process 200A, consistent with embodiments of the disclosure. For example, the encoding process 200A can be performed by an encoder. As shown in FIG. 2A, the encoder can encode video sequence 202 into video bitstream 228 according to process 200A. Similar to video sequence 100 in FIG. 1, video sequence 202 can include a set of pictures (referred to as “original pictures”) arranged in a temporal order. Similar to structure 110 in FIG. 1, each original picture of video sequence 202 can be divided by the encoder into basic processing units, basic processing sub-units, or regions for processing. In some embodiments, the encoder can perform process 200A at the level of basic processing units for each original picture of video sequence 202. For example, the encoder can perform process 200A in an iterative manner, in which the encoder can encode a basic processing unit in one iteration of process 200A. In some embodiments, the encoder can perform process 200A in parallel for regions (e.g., regions 114-118) of each original picture of video sequence 202.

In FIG. 2A, the encoder can feed a basic processing unit (referred to as an “original BPU”) of an original picture of video sequence 202 to prediction stage 204 to generate prediction data 206 and predicted BPU 208. The encoder can subtract predicted BPU 208 from the original BPU to generate residual BPU 210. The encoder can feed residual BPU 210 to transform stage 212 and quantization stage 214 to generate quantized transform coefficients 216. The encoder can feed prediction data 206 and quantized transform coefficients 216 to binary coding stage 226 to generate video bitstream 228. Components 202, 204, 206, 208, 210, 212, 214, 216, 226, and 228 can be referred to as a “forward path.” During process 200A, after quantization stage 214, the encoder can feed quantized transform coefficients 216 to inverse quantization stage 218 and inverse transform stage 220 to generate reconstructed residual BPU 222. The encoder can add reconstructed residual BPU 222 to predicted BPU 208 to generate prediction reference 224, which is used in prediction stage 204 for the next iteration of process 200A. Components 218, 220, 222, and 224 of process 200A can be referred to as a “reconstruction path.” The reconstruction path can be used to ensure that both the encoder and the decoder use the same reference data for prediction.

The encoder can perform process 200A iteratively to encode each original BPU of the original picture (in the forward path) and generate predicted reference 224 for encoding the next original BPU of the original picture (in the reconstruction path). After encoding all original BPUs of the original picture, the encoder can proceed to encode the next picture in video sequence 202.

Referring to process 200A, the encoder can receive video sequence 202 generated by a video capturing device (e.g., a camera). The term “receive” used herein can refer to receiving, inputting, acquiring, retrieving, obtaining, reading, accessing, or any action in any manner for inputting data.

At prediction stage 204, at a current iteration, the encoder can receive an original BPU and prediction reference 224, and perform a prediction operation to generate prediction data 206 and predicted BPU 208. Prediction reference 224 can be generated from the reconstruction path of the previous iteration of process 200A. The purpose of prediction stage 204 is to reduce information redundancy by extracting prediction data 206 that can be used to reconstruct the original BPU as predicted BPU 208 from prediction data 206 and prediction reference 224.

Ideally, predicted BPU 208 can be identical to the original BPU. However, due to non-ideal prediction and reconstruction operations, predicted BPU 208 is generally slightly different from the original BPU. For recording such differences, after generating predicted BPU 208, the encoder can subtract it from the original BPU to generate residual BPU 210. For example, the encoder can subtract values (e.g., greyscale values or RGB values) of samples of predicted BPU 208 from values of corresponding samples of the original BPU. Each sample of residual BPU 210 can have a residual value as a result of such subtraction between the corresponding samples of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

To further compress residual BPU 210, at transform stage 212, the encoder can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, the encoder can restore residual BPU 210 by an inverse operation of the transform (referred to as an “inverse transform”). For example, to restore a sample of residual BPU 210, the inverse transform can be multiplying values of corresponding samples of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 210 without receiving the base patterns from the encoder. Compared with residual BPU 210, the transform coefficients can have fewer bits, but they can be used to reconstruct residual BPU 210 without significant quality deterioration. Thus, residual BPU 210 is further compressed.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized transform coefficients 216 by dividing each transform coefficient by an integer value (referred to as a “quantization scale factor”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 216, by which the transform coefficients are further compressed. The quantization process is also invertible, in which quantized transform coefficients 216 can be reconstructed to the transform coefficients in an inverse operation of the quantization (referred to as “inverse quantization”).

Because the encoder disregards the remainders of such divisions in the rounding operation, quantization stage 214 can be lossy. Typically, quantization stage 214 can contribute the most information loss in process 200A. The larger the information loss is, the fewer bits the quantized transform coefficients 216 can need. For obtaining different levels of information loss, the encoder can use different values of the quantization parameter or any other parameter of the quantization process.

At binary coding stage 226, the encoder can encode prediction data 206 and quantized transform coefficients 216 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 206 and quantized transform coefficients 216, the encoder can encode other information at binary coding stage 226, such as, for example, a prediction mode used at prediction stage 204, parameters of the prediction operation, a transform type at transform stage 212, parameters of the quantization process (e.g., quantization parameters), an encoder control parameter (e.g., a bitrate control parameter), or the like. The encoder can use the output data of binary coding stage 226 to generate video bitstream 228. In some embodiments, video bitstream 228 can be further packetized for network transmission.

Referring to the reconstruction path of process 200A, at inverse quantization stage 218, the encoder can perform inverse quantization on quantized transform coefficients 216 to generate reconstructed transform coefficients. At inverse transform stage 220, the encoder can generate reconstructed residual BPU 222 based on the reconstructed transform coefficients. The encoder can add reconstructed residual BPU 222 to predicted BPU 208 to generate prediction reference 224 that is to be used in the next iteration of process 200A.

It should be noted that other variations of the process 200A can be used to encode video sequence 202. In some embodiments, stages of process 200A can be performed by the encoder in different orders. In some embodiments, one or more stages of process 200A can be combined into a single stage. In some embodiments, a single stage of process 200A can be divided into multiple stages. For example, transform stage 212 and quantization stage 214 can be combined into a single stage. In some embodiments, process 200A can include additional stages. In some embodiments, process 200A can omit one or more stages in FIG. 2A.

FIG. 2B illustrates a schematic diagram of another example encoding process 200B, consistent with embodiments of the disclosure. Process 200B can be modified from process 200A. For example, process 200B can be used by an encoder conforming to a hybrid video coding standard (e.g., H.26x series). Compared with process 200A, the forward path of process 200B additionally includes mode decision stage 230 and divides prediction stage 204 into spatial prediction stage 2042 and temporal prediction stage 2044. The reconstruction path of process 200B additionally includes loop filter stage 232 and buffer 234.

Generally, prediction techniques can be categorized into two types: spatial prediction and temporal prediction. Spatial prediction (e.g., an intra-picture prediction or “intra prediction”) can use samples from one or more already coded neighboring BPUs in the same picture to predict the current BPU. That is, prediction reference 224 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the current BPU. That is, prediction reference 224 in the temporal prediction can include the coded pictures. The temporal prediction can reduce the inherent temporal redundancy of the pictures.

Referring to process 200B, in the forward path, the encoder performs the prediction operation at spatial prediction stage 2042 and temporal prediction stage 2044. For example, at spatial prediction stage 2042, the encoder can perform the intra prediction. For an original BPU of a picture being encoded, prediction reference 224 can include one or more neighboring BPUs that have been encoded (in the forward path) and reconstructed (in the reconstructed path) in the same picture. The encoder can generate predicted BPU 208 by extrapolating the neighboring BPUs. The extrapolation technique can include, for example, a linear extrapolation or interpolation, a polynomial extrapolation or interpolation, or the like. In some embodiments, the encoder can perform the extrapolation at the sample level, such as by extrapolating values of corresponding samples for each sample of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at temporal prediction stage 2044, the encoder can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 222 to predicted BPU 208 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. The encoder can record the direction and distance of such a motion as a “motion vector.” When multiple reference pictures are used (e.g., as picture 106 in FIG. 1), the encoder can search for a matching region and determine its associated motion vector for each reference picture. In some embodiments, the encoder can assign weights to sample values of the matching regions of respective matching reference pictures.

The motion estimation can be used to identify various types of motions, such as, for example, translations, rotations, zooming, or the like. For inter prediction, prediction data 206 can include, for example, locations (e.g., coordinates) of the matching region, the motion vectors associated with the matching region, the number of reference pictures, weights associated with the reference pictures, or the like.

For generating predicted BPU 208, the encoder can perform an operation of “motion compensation.” The motion compensation can be used to reconstruct predicted BPU 208 based on prediction data 206 (e.g., the motion vector) and prediction reference 224. For example, the encoder can move the matching region of the reference picture according to the motion vector, in which the encoder can predict the original BPU of the current picture. When multiple reference pictures are used (e.g., as picture 106 in FIG. 1), the encoder can move the matching regions of the reference pictures according to the respective motion vectors and average sample values of the matching regions. In some embodiments, if the encoder has assigned weights to sample values of the matching regions of respective matching reference pictures, the encoder can add a weighted sum of the sample values of the moved matching regions.

In some embodiments, the inter prediction can be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (e.g., picture 102) precedes picture 104. Bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at both temporal directions with respect to picture 104.

Still referring to the forward path of process 200B, after spatial prediction 2042 and temporal prediction stage 2044, at mode decision stage 230, the encoder can select a prediction mode (e.g., one of the intra prediction or the inter prediction) for the current iteration of process 200B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 208 and predicted data 206.

In the reconstruction path of process 200B, if intra prediction mode has been selected in the forward path, after generating prediction reference 224 (e.g., the current BPU that has been encoded and reconstructed in the current picture), the encoder can directly feed prediction reference 224 to spatial prediction stage 2042 for later usage (e.g., for extrapolation of a next BPU of the current picture). The encoder can feed prediction reference 224 to loop filter stage 232, at which the encoder can apply a loop filter to prediction reference 224 to reduce or eliminate distortion (e.g., blocking artifacts) introduced during coding of the prediction reference 224. The encoder can apply various loop filter techniques at loop filter stage 232, such as, for example, deblocking, sample adaptive offsets, adaptive loop filters, or the like. The loop-filtered reference picture can be stored in buffer 234 (or “decoded picture buffer”) for later use (e.g., to be used as an inter-prediction reference picture for a future picture of video sequence 202). The encoder can store one or more reference pictures in buffer 234 to be used at temporal prediction stage 2044. In some embodiments, the encoder can encode parameters of the loop filter (e.g., a loop filter strength) at binary coding stage 226, along with quantized transform coefficients 216, prediction data 206, and other information.

FIG. 3A illustrates a schematic diagram of an example decoding process 300A, consistent with embodiments of the disclosure. Process 300A can be a decompression process corresponding to the compression process 200A in FIG. 2A. In some embodiments, process 300A can be similar to the reconstruction path of process 200A. A decoder can decode video bitstream 228 into video stream 304 according to process 300A. Video stream 304 can be very similar to video sequence 202. However, due to the information loss in the compression and decompression process (e.g., quantization stage 214 in FIGS. 2A-2B), generally, video stream 304 is not identical to video sequence 202. Similar to processes 200A and 200B in FIGS. 2A-2B, the decoder can perform process 300A at the level of basic processing units (BPUs) for each picture encoded in video bitstream 228. For example, the decoder can perform process 300A in an iterative manner, in which the decoder can decode a basic processing unit in one iteration of process 300A. In some embodiments, the decoder can perform process 300A in parallel for regions (e.g., regions 114-118) of each picture encoded in video bitstream 228.

In FIG. 3A, the decoder can feed a portion of video bitstream 228 associated with a basic processing unit (referred to as an “encoded BPU”) of an encoded picture to binary decoding stage 302. At binary decoding stage 302, the decoder can decode the portion into prediction data 206 and quantized transform coefficients 216. The decoder can feed quantized transform coefficients 216 to inverse quantization stage 218 and inverse transform stage 220 to generate reconstructed residual BPU 222. The decoder can feed prediction data 206 to prediction stage 204 to generate predicted BPU 208. The decoder can add reconstructed residual BPU 222 to predicted BPU 208 to generate predicted reference 224. In some embodiments, predicted reference 224 can be stored in a buffer (e.g., a decoded picture buffer in a computer memory). The decoder can feed predicted reference 224 to prediction stage 204 for performing a prediction operation in the next iteration of process 300A.

The decoder can perform process 300A iteratively to decode each encoded BPU of the encoded picture and generate predicted reference 224 for encoding the next encoded BPU of the encoded picture. After decoding all encoded BPUs of the encoded picture, the decoder can output the picture to video stream 304 for display and proceed to decode the next encoded picture in video bitstream 228.

At binary decoding stage 302, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 206 and quantized transform coefficients 216, the decoder can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, the decoder can depacketize video bitstream 228 before feeding it to binary decoding stage 302.

FIG. 3B illustrates a schematic diagram of another example decoding process 300B, consistent with embodiments of the disclosure. Process 300B can be modified from process 300A. For example, process 300B can be used by a decoder conforming to a hybrid video coding standard (e.g., H.26x series). Compared with process 300A, process 300B additionally divides prediction stage 204 into spatial prediction stage 2042 and temporal prediction stage 2044, and additionally includes loop filter stage 232 and buffer 234.

In process 300B, for an encoded basic processing unit (referred to as a “current BPU”) of an encoded picture (referred to as a “current picture”) that is being decoded, prediction data 206 decoded from binary decoding stage 302 by the decoder can include various types of data, depending on what prediction mode was used to encode the current BPU by the encoder. For example, if intra prediction was used by the encoder to encode the current BPU, prediction data 206 can include a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by the encoder to encode the current BPU, prediction data 206 can include a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 2042 or a temporal prediction (e.g., the inter prediction) at temporal prediction stage 2044. The details of performing such spatial prediction or temporal prediction are described in FIG. 2B and will not be repeated hereinafter. After performing such spatial prediction or temporal prediction, the decoder can generate predicted BPU 208. The decoder can add predicted BPU 208 and reconstructed residual BPU 222 to generate prediction reference 224, as described in FIG. 3A.

In process 300B, the decoder can feed predicted reference 224 to spatial prediction stage 2042 or temporal prediction stage 2044 for performing a prediction operation in the next iteration of process 300B. For example, if the current BPU is decoded using the intra prediction at spatial prediction stage 2042, after generating prediction reference 224 (e.g., the decoded current BPU), the decoder can directly feed prediction reference 224 to spatial prediction stage 2042 for later usage (e.g., for extrapolation of a next BPU of the current picture). If the current BPU is decoded using the inter prediction at temporal prediction stage 2044, after generating prediction reference 224 (e.g., a reference picture in which all BPUs have been decoded), the decoder can feed prediction reference 224 to loop filter stage 232 to reduce or eliminate distortion (e.g., blocking artifacts). The decoder can apply a loop filter to prediction reference 224, in a way as described in FIG. 2B. The loop-filtered reference picture can be stored in buffer 234 (e.g., a decoded picture buffer in a computer memory) for later use (e.g., to be used as an inter-prediction reference picture for a future encoded picture of video bitstream 228). The decoder can store one or more reference pictures in buffer 234 to be used at temporal prediction stage 2044. In some embodiments, prediction data can further include parameters of the loop filter (e.g., a loop filter strength). In some embodiments, prediction data includes parameters of the loop filter when the prediction mode indicator of prediction data 206 indicates that inter prediction was used to encode the current BPU.

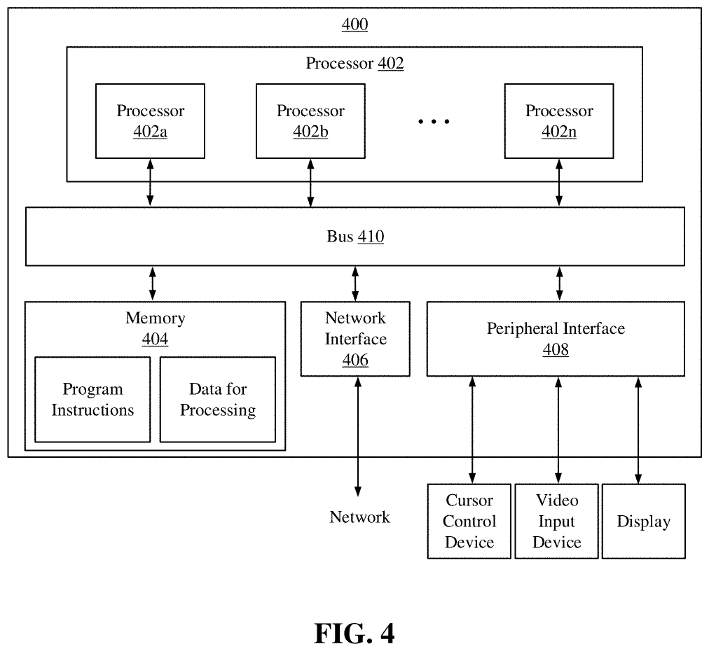

FIG. 4 is a block diagram of an example apparatus 400 for encoding or decoding a video, consistent with embodiments of the disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes 200A, 200B, 300A, or 300B) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, an near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process 200A, 200B, 300A, or 300B) can be implemented as any combination of any software or hardware modules in apparatus 400. For example, some or all stages of process 200A, 200B, 300A, or 300B can be implemented as one or more software modules of apparatus 400, such as program instructions that can be loaded into memory 404. For another example, some or all stages of process 200A, 200B, 300A, or 300B can be implemented as one or more hardware modules of apparatus 400, such as a specialized data processing circuit (e.g., an FPGA, an ASIC, an NPU, or the like).

An intra prediction smoothing (IPS) filter method can add a filtering process to the intra prediction blocks. The IPS method filters the predicted samples of a block predicted by an intra prediction mode to obtain the final filtered predicted samples. In this way, the prediction blocks can be smoothed and the coding efficiency can be improved.

The IPS can be performed as follows:

1) Prediction process: Using an intra prediction mode to generate a prediction block;

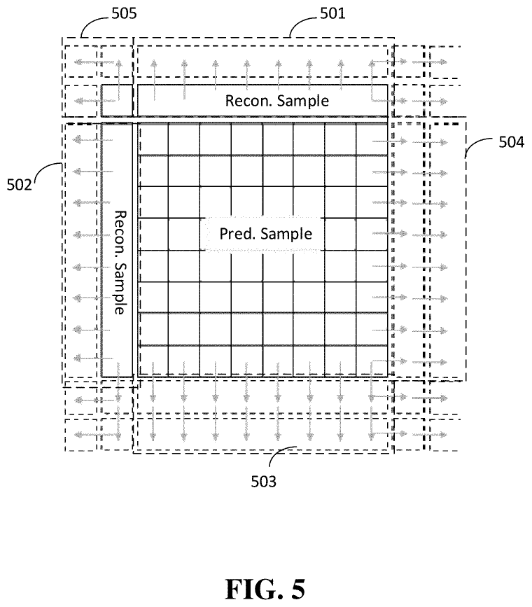

2) Padding process: Padding the four adjacent rows, the four adjacent columns and the adjacent corners of the current prediction block with the reconstructed samples of the adjacent reference row and column and the predicted samples within the prediction block. FIG. 5 is a schematic diagram illustrating an exemplary IPS padding process, according to some embodiments of the present disclosure. As shown in FIG. 5, the padding process is performed as follows:
a) Top two rows: the reconstructed samples of the top row adjacent to the prediction block are used to fill the two adjacent top rows 501.
b) Left two columns: the reconstructed samples of the left column adjacent to the prediction block are used to fill the two adjacent left columns 502.
c) Bottom two rows: the predicted samples of the last two rows within the prediction block are used to fill the two adjacent bottom rows 503.
d) Right two columns: the predicted samples of the last two columns within the prediction block are used to fill the two adjacent right columns 504.
e) Adjacent corners: the samples at the four adjacent corners 505 of the prediction block are filled with adjacent filled samples.

3) Filtering process: Filtering the prediction block with an intra prediction smoothing filter to obtain the final filtered prediction block.

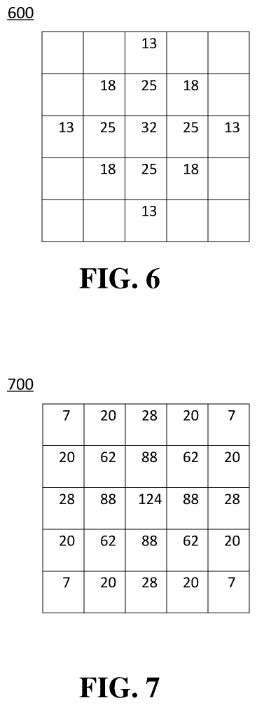

FIG. 6 is a schematic diagram illustrating an exemplary 13-tap filter 600, according to some embodiments of the present disclosure. As shown in FIG. 6, the weights of the 13-tap filter 600 are symmetrical in each of the horizontal and vertical directions. FIG. 7 is a schematic diagram illustrating an exemplary 25-tap filter 700, according to some embodiments of the present disclosure. As shown in FIG. 7, the weights of the 25-tap filter 700 are symmetrical in each of the horizontal and in vertical directions.

When filtering the current sample, the predicted value of the current sample is placed corresponding to the center of the filter (e.g., 32 in FIGS. 6, and 124 in FIG. 7) and the surrounding samples are respectively multiplied by the weights of the corresponding positions of the filter, then the products are added, and the sum of the products is finally divided by a sum of all the weights in the filter to obtain the final predicted value.

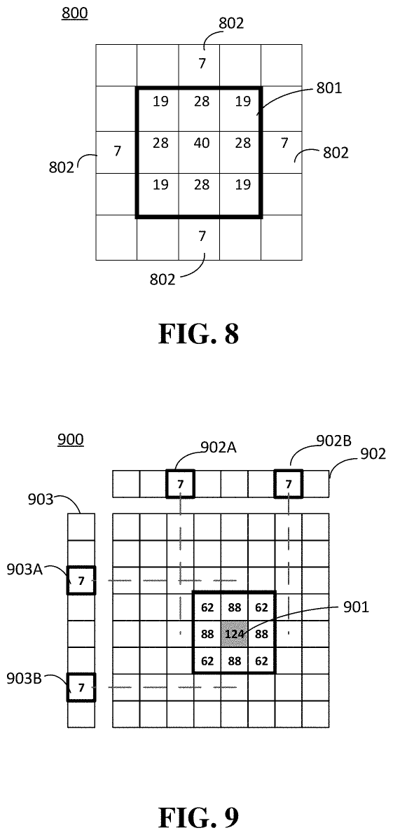

FIG. 8 is a schematic diagram illustrating another exemplary 13-tap filter 800, according to some embodiments of the present disclosure. As shown in FIG. 8, the filter 800 is grouped with internal weights 801 and external weights 802. The internal 9 weights 801 are used for the padded prediction block and the external 4 weights 802 are used for the 4 reference samples at the corresponding positions. Therefore, only one row and one column in each side need to be padded. In this disclosure, this 13-tap filter is called a 9+4 tap filter. FIG. 9 shows an exemplary of positions of the samples used in a 9+4 tap filter 900, according to some embodiments of the present disclosure. Specifically, as shown in FIG. 9, when filtering the current sample, the four used reference samples include: two samples with coordinates in the top reference row 902, the sample coordinates being equal to the current sample 901 (e.g., corresponding to the weight value 124) horizontal coordinate minus 2 and plus 2, respectively, e.g., samples 902A and 902B (corresponding to a weight value 7); and two samples with coordinates in the left reference column 903, the sample coordinates being equal to the current sample 901 vertical coordinate minus 2 and plus 2, respectively, e.g., samples 903A and 903B (corresponding to a weight value 7).

Consistent with the disclosed embodiments, an IPS flag is signaled to specify whether IPS is used for an intra prediction block. In some embodiments, the IPS can be only applied to luminance intra prediction blocks with the number of samples is greater than or equal to 64 and less than 4096. In some embodiments, the width of the prediction block is restricted to be less than 64.

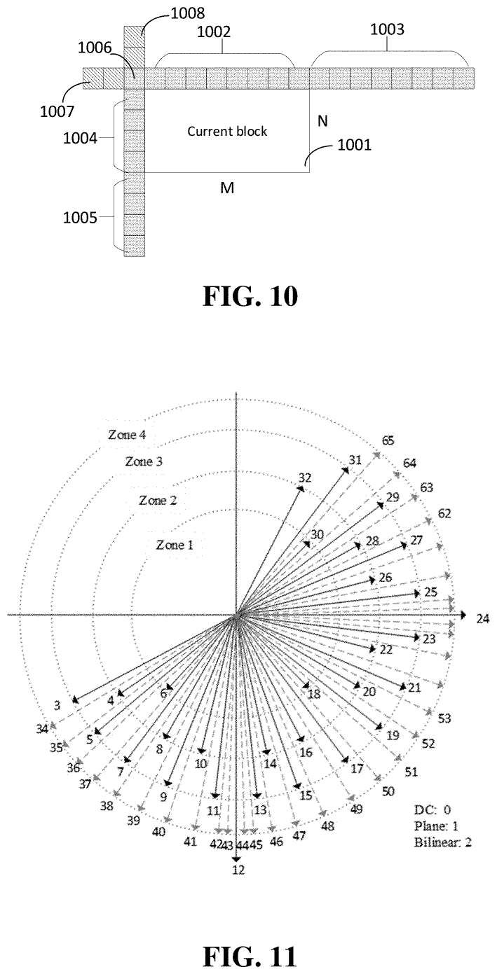

For intra prediction, the spatial neighboring reconstructed samples are used as the reference samples to predict the sample value of the current block. Generally, as the coding order is from left to right and from up to bottom, the left neighboring reconstructed samples and the top neighboring reconstructed samples are usually already coded when coding the current block. Thus, in an intra prediction, the top neighbouring reconstructed samples, the top-right neighboring reconstructed samples, the top-left neighboring reconstructed samples, the left neighboring reconstructed samples and the bottom-left neighboring reconstructed samples are used as the reference samples for the current block. FIG. 10 is a schematic diagram illustrating exemplary intra prediction reference samples, according to some embodiments of the present disclosure. As shown in FIG. 10, a current block 1001 with a size of M×N is to be predicted. The samples filled with pattern of dots (e.g., 1002-1006) are the reference samples that are the reconstructed samples of the neighboring block. In AVS3, the number of top reference samples 1002 is M, the number of top-right reference samples 1003 is M, the number of left reference samples 1004 is N, the number of bottom-left reference samples 1005 is N, the number of top-left reference samples 1006 is 1. Besides these reference samples, as shown in FIG. 10, the samples filled with pattern of diagonal lines (e.g., 1007 and 1008) are also used as the reference samples, which are padded from the samples filled with pattern of dots (e.g., 1002 and 1004). There are two padded samples 1007 in the top row and two padded samples 1008 in the left column.

In the present disclosure, the top reference samples 1002 are denoted as r[1] to r[M], the top-right reference samples 1003 are denoted as r[M+1] to r[2M]; the left reference samples 1004 are denoted as c[1] to c[N], the bottom-left reference samples 1005 are denoted as c[N+1] to c[2N], the top-left reference sample 1006 is denoted as r[0] or c[0], the padded samples 1007 in top row are denoted as r[−1] and r[−2], and the padded samples 1008 in left column are denoted as c[−1] and c[−2].

FIG. 11 illustrates different prediction modes in intra prediction, according to some embodiments of the present disclosure. As shown in FIG. 11, in intra prediction, there are multiple prediction modes with different indexes. In AVS3, there are 65 intra prediction modes (e.g., index 0-32, and 34-65) which are direct current (DC) mode (e.g., mode 0 with index 0), plane mode (e.g., mode 1 with index 1), bilinear mode (e.g., mode 2 with index 2) and 62 angular modes (e.g., mode 3 to mode 32, and mode 34 to mode 65 with index 3-32 and 34-65).

DC mode (e.g., mode 0) is a mode in which the direct current of the left reference samples or top reference samples is used. If both the left reference samples and the top reference samples are available, the averaged value of the left reference samples and top reference samples is used as the predicted value of all the samples in the current block. If left reference samples are available and top reference samples are not available, the averaged value of left reference samples is used as the predicted value of all the samples in the current block. If the left reference samples are not available and the top reference samples are available, the averaged value of the top reference samples is used as the predicted value of all the samples in the current block. If both the left reference samples and the top reference sample are not available, the median of the sample value range is used as the predicted value of all the samples in the current block.

Plane mode (e.g., mode 1) is a mode in which the predicted values of samples are all in a plane. Therefore, the predicted value of each sample follows a two-dimension linear model.

Referring back to FIG. 10, first, the top reference samples 1002 and top-left reference sample 1006 are used to derive the slope in the horizontal direction (picture width direction), and the left reference samples 1004 and top-left reference sample 1006 are used to derive the slope in vertical direction (picture height direction), based on Eq. (1) and Eq. (2),

ib=((ih«5)×imh+(1«(ish-1)))»ish Eq. (1)

is=((iv«5)×imv+(1«(isv-1)))»isv Eq. (2)

where ib is the horizontal slope, is is the vertical slope, imh, imv, ish and isv are dependent on the size of the block. In some embodiments, imh=ibMult[Log(M)−2], ish=ibShift[Log(M)−2], imv=ibMult[Log(N)−2], isv=ibShift[Log(N)−2], and ibMult[5]={13, 17, 5, 11, 23}, ibShift[5]={7, 10, 11, 15, 19}. The parameters ih and iv are derived based on Eq. (3) and Eq. (4),

$$\begin{matrix}ih = {\sum }_{i = 0}^{( M ⪢ 1 ) - 1} ( i + 1 ) \times ( r [ ( M ⪢ 1 ) + 1 + i ] - r [ ( M ⪢ 1 ) - 1 - i ] ) & Eq . ( 3 ) \\ iv = {\sum }_{i = 0}^{( N ⪢ 1 ) - 1} ( i + 1 ) \times ( c [ ( N ⪢ 1 ) + 1 + i ] - c [ ( N ⪢ 1 ) - 1 - i ] ) & Eq . ( 4 )\end{matrix}$$

Second, the averaged value of top-right samples 1003 and bottom-left samples 1005 is used as the predicted value of center sample in the current block based on Eq. (5),

is=(r[M]+c[N])/2«5 Eq. (5)

where is is the averaged value after right shifting 5 bits.

Third, based on the center value of the slope in two directions, the predicted values of all the samples in the current block are derived based on Eq. (6)

Pred[x][y]=(ia+(x−((M»1)−1))×ib+(y−((N»1)−1))xic+16)»5(x=0˜M−1, y=0˜N−1) Eq. (6)

where Pred[x][y] is the predicted value of sample located in (x, y) in the current block.

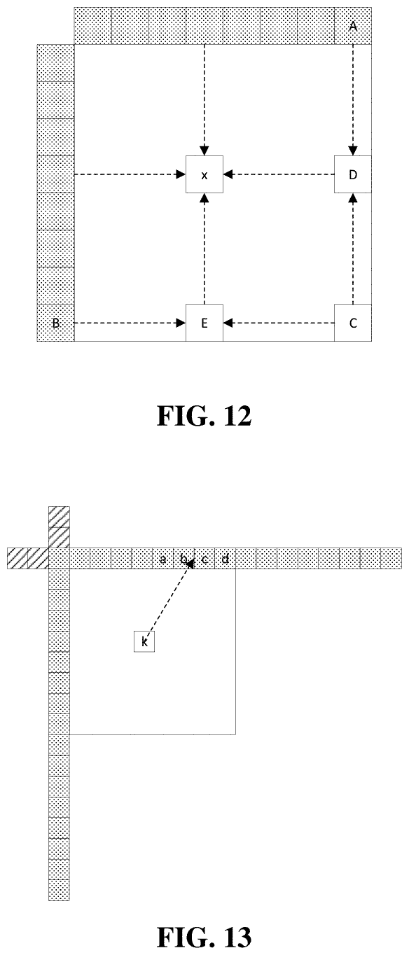

The predicted value of bilinear mode is the averaged value of two linear interpolated values. FIG. 12 is a schematic diagram illustrating an exemplary prediction of bilinear mode, according to some embodiments of the present disclosure. As shown in FIG. 12, the predicted value of bottom-right corner sample C of the current block is the weighted averaged of the top-right reference sample A and the bottom-left reference sample B according to the distance from A to C and the distance from B to C. For the right boundary (e.g., D for example), the predicted value is generated by weighted averaging the reference sample A and the predicted value of the corner sample C according to the distance between the predicted sample and the reference sample A. For the bottom boundary samples (e.g., E for example), the predicted value is generated by weighted averaging the reference sample B and the predicted value of the corner sample C according to the distance between the predicted sample and the reference sample B. Remaining samples located within the block, for example sample X, are then predicted by weighted averaging the predicted values of the horizontal linear prediction and vertical linear prediction. The predicted value of horizontal linear prediction is generated by weighted averaging horizontally corresponding left reference sample and the right boundary sample according to the distance from current predicted sample to the corresponding left reference sample and the distance from the current predicted sample to the corresponding right boundary sample. The predicted value of vertical linear prediction is generated by weighted averaging vertically corresponding top reference sample and the bottom boundary sample according to the distance from current predicted sample to the corresponding top reference sample and the distance from the current predicted sample to the corresponding bottom boundary sample.

The prediction process could be described as the following Eq. (7),

$$P r e d [ x ] [ y ] = ( ( ( ( i a - c [ y + 1 ] ) \times ( x + 1 ) ) ⪡ Log ( N ) ) + ( ( ( i b - r [ x + 1 ] ) \times ( y + 1 ) ) ⪡ Log ( M ) ) + ( ( r [ x + 1 ] + c [ y + 1 ] ) ⪡ ( Log ( M ) + Log ( N ) ) ) + ( ( ic ⪡ 1 ) - i a - i b ) \times x \times y + ( 1 ⪡ ( Log ( M ) + Log ( N ) ) ) ) ⪢ ( Log ( M ) + Log ( N ) + 1 ) , ( x = 0 \text{\textasciitilde} M - 1 , y = 0 \text{\textasciitilde} N - 1 ) \qquad Eq . ( 7 )$$

where is denotes sample A which is equal to r[M], ib denotes sample B which is equal to c[N], and is denotes the sample C.

In the angular mode, the predicted value is generated by directional extrapolation or interpolation of the reference samples. In AVS3, there are 62 different directions (e.g., mode 3 to mode 32, and mode 34 to mode 65 as shown in FIG. 11). First, the reference position which is referred to by the current sample to be predicted along a certain direction is calculated. Then the reference sample value of that position is interpolated using the surrounding 4 integer reference samples.

FIG. 13 is a schematic diagram illustrating an exemplary prediction of angular mode, according to some embodiments of the present disclosure. As in FIG. 13, the current sample is K, which refers to a position between integer reference sample b and the integer reference sample c in the top reference sample row along a certain direction. Then reference samples a, b, c and d are used to derive the predicted value of sample K based on Eq. (8),

Predk=(f₀×a+f₁×b+f₂×c+f₃×d)»shift Eq. (8)

wherein Predk is the predicted value of sample K, f₀, f₁, f₂ and f₃ are interpolation filter coefficients and the shift is the right shift number which is decided by the sum of f₀, f₁, f₂ and f₃.

In AVS3, an inter prediction filter is applied to the direct mode to filter the prediction blocks. If the current block is coded by the direct mode and is not coded by the AFFINE or UMVE mode, a flag is signaled to indicate whether the inter prediction filter (InterPF) is used or not. If InterPF is used, an index is signaled to indicate which filter method is used. In the decoder side, the decoder performs the same filter operation as the encoder when the parsed InterPF flag is true. That is the InterPF is used.

The filter uses the prediction block and neighboring samples in the above, below, right, and left of the current block to do weighted average to get the final prediction block. The InterPF method generates the final prediction signal by weighting the two prediction blocks Pred_inter and Pred_Q. The Pred_inter is derived by inter prediction. The Pred_Q is derived by the reconstructed reference samples of the current block like intra prediction.

If the interPF index is equal to 0, the following filter method is used based on Eq. (9) - Eq. (12):

Pred(x,y)=(Pred_inter(x,y)*5+Pred_Q(x,y)*3)»3 Eq. (9)

Pred_Q(x,y)=(Pred_V(x,y)+Pred_H(x,y)+1)»2 Eq. (10)

Pred_V(x,y)=((h-1-y)*Rec(x,-1)+(y+1)*Rec(-1,h)+(h»1))»log2(h) Eq. (11)

Pred_H(x,y)=((w-1-x)*Rec(-1,y)+(x+1)*Rec(w,-1)+(w»1))»log2(w) Eq. (12)

where Pred_inter is the unfiltered prediction block, Pred is the final prediction block, and Rec represents the reconstructed neighboring samples. The width and height of the current block are represented by w and h, respectively.

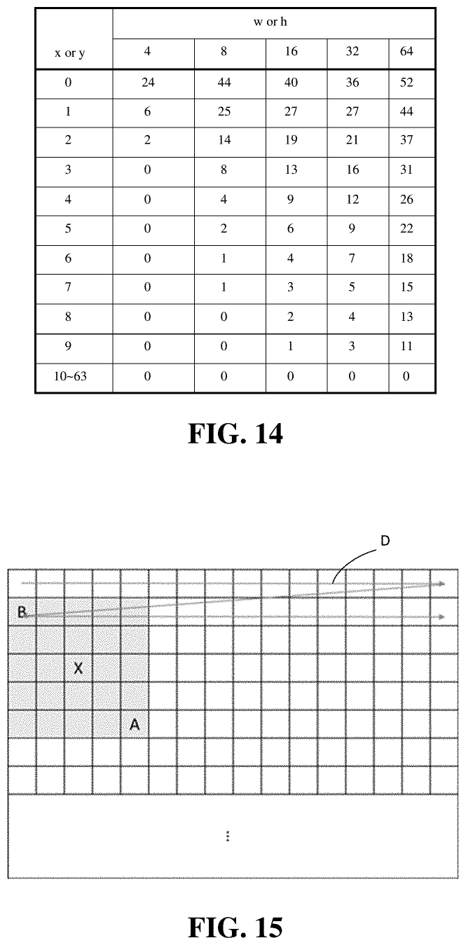

FIG. 14 is an exemplary look up table for interPF, according to some embodiments of the present disclosure. If the interPF index is equal to 1, a filter method is used based on Eq. (13):

Pred(x,y)=Clip ((f(x)*Rec(-1,y)+f(y)*Rec(x,-1)+(64-f(x)-f(y))*Pred_inter(x,y)+32)»6) Eq. (13)

where f(x) and f(y) can be obtained by a look up table as shown in FIG. 14.

Conventionally, IPS adds an operation to filter each predicted sample of the intra prediction block after performing intra prediction to obtain the final filtered prediction block. Each prediction sample needs to be filtered with 12 or 24 surrounding predicted samples to jointly calculate the current predicted sample, which causes some issues. The existing IPS design is not friendly to hardware implementation.

For example, for a 13-tap filter, there are 13 multiplications, 12 additions, and 1 shift introduced to the intra prediction, while for a 25-tap filter, there are 25 multiplications, 24 additions, and 1 shift introduced to the intra prediction.

Moreover, since the predicted samples need to wait for being used in the IPS filtering process of the surrounding predicted samples before they can be output for the next coding process, a latency is introduced to the hardware pipeline and more buffering is required. FIG. 15 is a schematic diagram illustrating an exemplary IPS process for sample X, according to some embodiments of the present disclosure. As shown in FIG. 15, the intra prediction of each sample may be predicted in raster scan order, for example, along the direction of the arrow D. To filter the sample “X”, it requires the sample “A” to be predicted. Thus, to output the sample “X” to next coding process, it required to delay at least 34 samples (then latency is introduced). In terms of buffering issue, 5 rows of prediction samples (e.g., 5×16 samples as shown in FIG. 15) need to be buffered in order to perform the filtering.

The present disclosure provides embodiments to make the IPS friendly to hardware implementation and reduce the number of operations, the hardware pipeline latency and the buffer size.

In some embodiments, the IPS can be performed based on sub-blocks. The IPS can be performed parallel for each sub-block, so that the hardware pipeline latency and the buffering needed can be reduced.

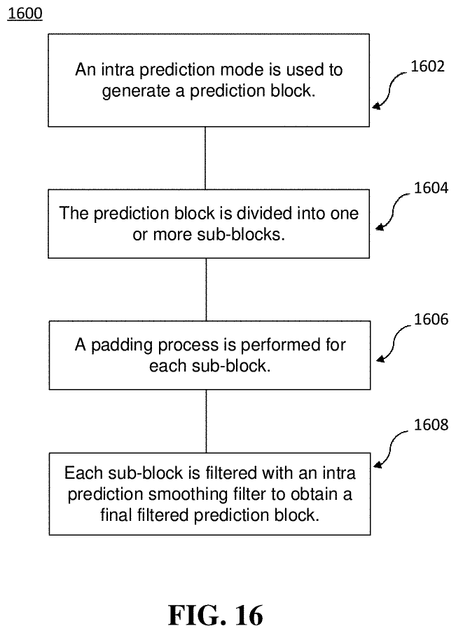

FIG. 16 illustrates a flow-chart of an exemplary method 1600 for improving intra prediction smoothing (IPS), according to some embodiments of the present disclosure. Method 1600 can be performed by an encoder (e.g., by process 200A of FIG. 2A or 200B of FIG. 2B) or performed by one or more software or hardware components of an apparatus (e.g., apparatus 400 of FIG. 4). For example, one or more processors (e.g., processor 402 of FIG. 4) can perform method 1600. In some embodiments, method 1600 can be implemented by a computer program product, embodied in a computer-readable medium, including computer-executable instructions, such as program code, executed by computers (e.g., apparatus 400 of FIG. 4). Referring to FIG. 16, method 1600 may include the following steps 1602A-1608A.

At step 1602, an intra prediction mode is used to generate a prediction block. The prediction block is generated by an intra prediction mode, such that the prediction block can be filtered with an IPS filter to improve the prediction performance.

At step 1604, the prediction block is divided into one or more sub-blocks. Generally, prediction samples are arranged in a matrix form in the prediction block. Therefore, a prediction block can be divided into one or more sub-blocks. Each sub-block may include a number of prediction samples.

At step 1606, a padding process is performed for each sub-block. The padding process can be performed for each sub-block in parallel. Thus, the padding efficiency is improved.

At step 1608, each sub-block is filtered with an intra prediction smoothing filter to obtain a final filtered prediction block. Instead of filtering an entire prediction block in a raster scan order, the sub-blocks can be filtered with IPS simultaneously. The hardware pipeline latency and the buffer size of the filter are reduced.

In some embodiments, a W×H prediction block is divided into several M×H sub-blocks (e.g., the prediction block is divided in vertical direction). The prediction block is divided into

$$\frac{W}{M}$$

sub-blocks with the size of M×H, if W is greater than M, where W is the width of the prediction block, H is the height of the prediction block and M, for example, can be any value from the set {4,8,16,32,64,128}.

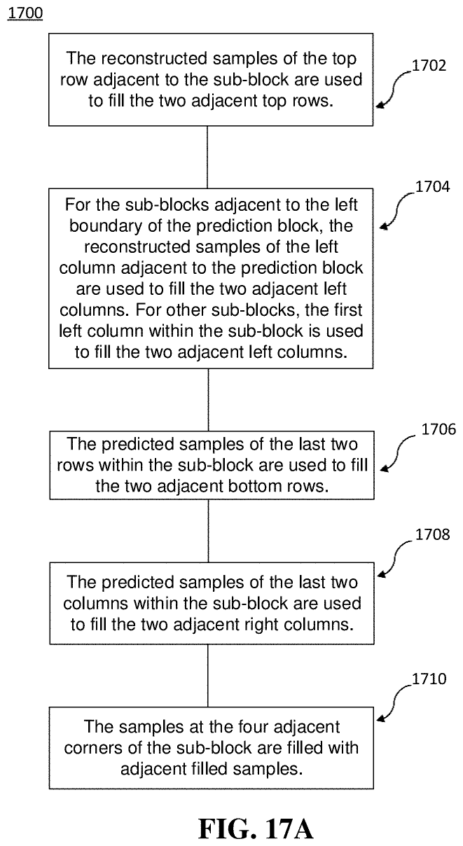

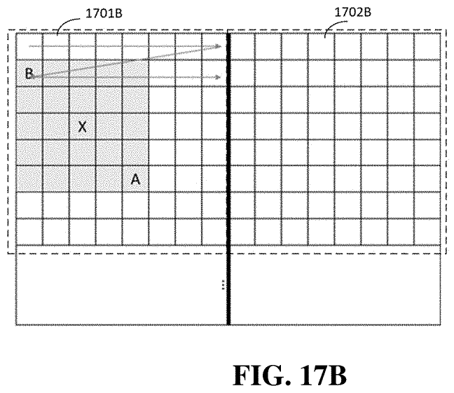

FIG. 17A illustrates a flow-chart of an exemplary method 1700 for dividing a M×H sub-block to perform the IPS, according to some embodiments of the present disclosure. It is appreciated that method 1600 can be part of step 1606 in method 1600 of FIG. 16. In some embodiment, the method 1700 may further include the following steps 1702-1710.

At step 1702, for top two rows, the reconstructed samples of the top row adjacent to the sub-block are used to fill the two adjacent top rows.

At step 1704, for left two columns, for the sub-blocks adjacent to the left boundary of the prediction block, the reconstructed samples of the left column adjacent to the prediction block are used to fill the two adjacent left columns. For other sub-blocks, the predicted samples of the first column within the sub-block are used to fill the two adjacent left columns.

At step 1706, for bottom two rows, the predicted samples of the last two rows within the sub-block are used to fill the two adjacent bottom rows.

At step 1708, for right two columns, the predicted samples of the last two columns within the sub-block are used to fill the two adjacent right columns.

At step 1710, for adjacent corners, the samples at the four adjacent corners of the sub-block are filled with adjacent filled samples.

FIG. 17B is a schematic diagram illustrating an exemplary IPS process for sample X in a sub-block, according to some embodiments of the present disclosure. As shown in FIG. 17B, the block is split into two 8×N sub-blocks (e.g., 1701B and 1702B). To filter the sample “X”, the delay is reduced from 34 samples (shown in FIGS. 15) to 18 samples. Moreover, the size of buffer is decreased.

In some embodiments, a W×H prediction block is divided into several W×N sub-blocks (e.g., the prediction block is divided in horizontal direction). The prediction block is divided into

$$\frac{H}{N}$$

sub-blocks with the size of W×N if H is greater than N, where W is the width of the prediction block, H is the height of the prediction block and N can be any value from the set {4,8,16,32,64,128}. Then, the padding and filtering processes are performed for each sub-block.

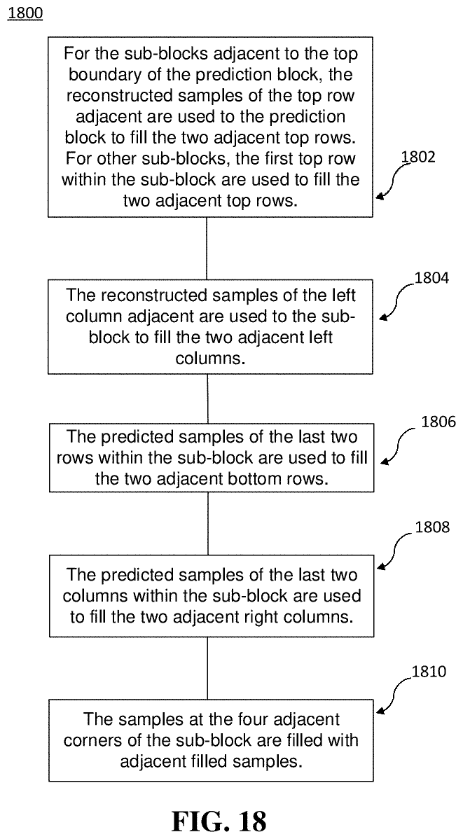

FIG. 18 illustrates a flow-chart of an exemplary method 1800 for dividing a W×N sub-block to perform the IPS, according to some embodiments of the present disclosure. It is appreciated that method 1800 can be part of step 1606 in method 1600 of FIG. 16. In some embodiment, the method 1800 may further include the following steps 1802-1810.

At step 1802, for top two rows: for the sub-blocks adjacent to the top boundary of the prediction block, the reconstructed samples of the top row adjacent are used to the prediction block to fill the two adjacent top rows. For other sub-blocks, the predicted samples of the first row within the sub-block are used to fill the two adjacent top rows.

At step 1804, for left two columns, the reconstructed samples of the left column adjacent are used to the sub-block to fill the two adjacent left columns.

At step 1806, for bottom two rows, the predicted samples of the last two rows within the sub-block are used to fill the two adjacent bottom rows.

At step 1808, for right two columns, the predicted samples of the last two columns within the sub-block are used to fill the two adjacent right columns.

At step 1810, for adjacent corners, the samples at the four adjacent corners of the sub-block are filled with adjacent filled samples.

In some embodiments, a W x H prediction block is divided into several M×N sub-blocks (e.g., the prediction block is divided in both vertical and horizontal directions). The prediction block is divided into

$$\frac{W}{M} \times \frac{H}{N}$$

sub-blocks with the size of M×N if W is greater than M or H is greater than N, where W is the width of the prediction block and H is the height of the prediction block. M and N can be any value from the set {4,8,16,32,64,128}. Then, the padding and filtering processes are performed for each sub-block.

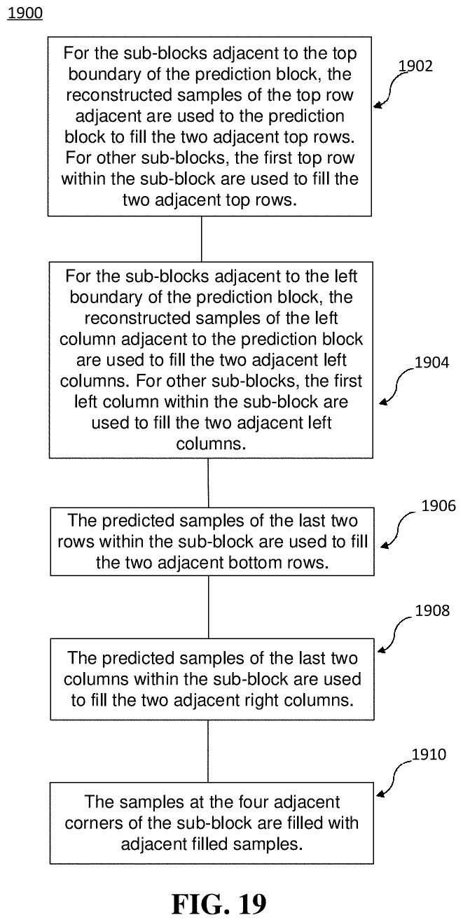

FIG. 19 illustrates a flow-chart of an exemplary method 1900 for dividing a M×N sub-block to perform the IPS, according to some embodiments of the present disclosure. It is appreciated that method 1900 can be part of step 1606 in method 1600 of FIG. 16. In some embodiment, the method 1900 may further include the following steps 1902-1910.

At step 1902, for top two rows: for the sub-blocks adjacent to the top boundary of the prediction block, the reconstructed samples of the top row adjacent are used to the prediction block to fill the two adjacent top rows. For other sub-blocks, the predicted samples of the first row within the sub-block are used to fill the two adjacent top rows.

At step 1904, for left two columns: for the sub-blocks adjacent to the left boundary of the prediction block, the reconstructed samples of the left column adjacent to the prediction block are used to fill the two adjacent left columns. For other sub-blocks, the predicted samples of the first column within the sub-block are used to fill the two adjacent left columns.

At step 1906, for bottom two rows, the predicted samples of the last two rows within the sub-block are used to fill the two adjacent bottom rows.

At step 1908, for right two columns, the predicted samples of the last two columns within the sub-block are used to fill the two adjacent right columns.

At step 1910, for adjacent corners, the samples at the four adjacent corners of the sub-block are filled with adjacent filled samples.

In some embodiments, the methods of splitting sub-blocks may depend on the order of predicting samples. The splitting direction is orthogonal to the order of prediction samples. Therefore, when the order of predicting the samples is in the horizontal raster scan order, a block is vertically divided into sub-blocks. When the order of predicting the samples is in the vertical raster scan order, a prediction block is horizontally divided into sub-blocks.

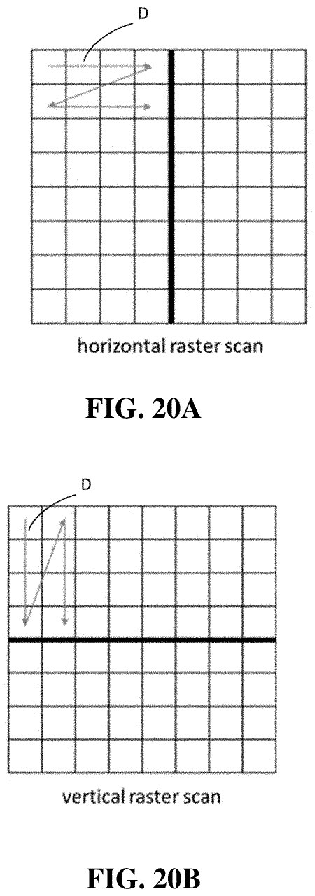

FIGS. 20A and 20B illustrate exemplary vertical splitting and horizontal splitting of a prediction block respectively, according to some embodiments of the present disclosure. As shown in FIG. 20A, if a horizontal raster scan (e.g., along the direction D) is applied, the prediction block is vertical split. As shown in FIG. 20B, if a vertical raster scan (e.g., along the direction D) is applied, the prediction block is horizontal split.

In some embodiments, some of the adjacent rows, columns and corners of each sub-block used for IPS can be obtained by the saved adjacent predicted samples from the adjacent sub-blocks that are before the current block in the raster scan order.

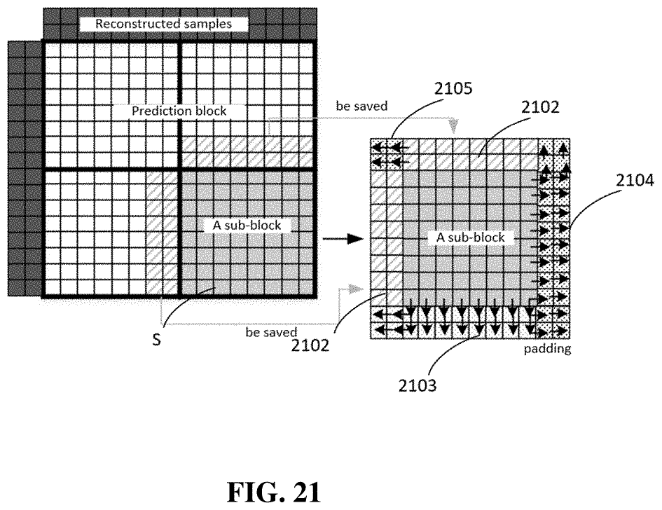

FIG. 21 illustrates an exemplary padding process for a sub-block S, according to some embodiments of the present disclosure. As shown in FIG. 21, a prediction block is split into four sub-blocks. Taken sub-block S in right-bottom of the prediction block for example, for the top adjacent rows 2101 and the left adjacent columns 2102 of the sub-block S, which is not adjacent to the top or left boundary of the prediction block, the adjacent predicted samples from the adjacent sub-blocks are saved to be used for filtering. The bottom adjacent rows 2103, the right adjacent columns 2014 and the adjacent corners 2105 of the sub-block are obtained by padding from the current sub-block S or saved samples (e.g., 2102). The arrows illustrate exemplary padding directions for the samples.

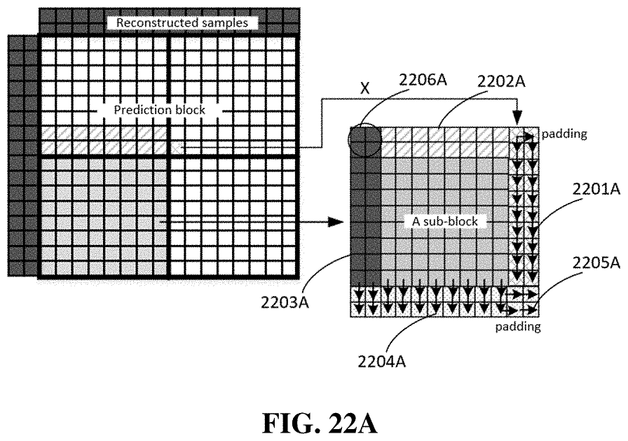

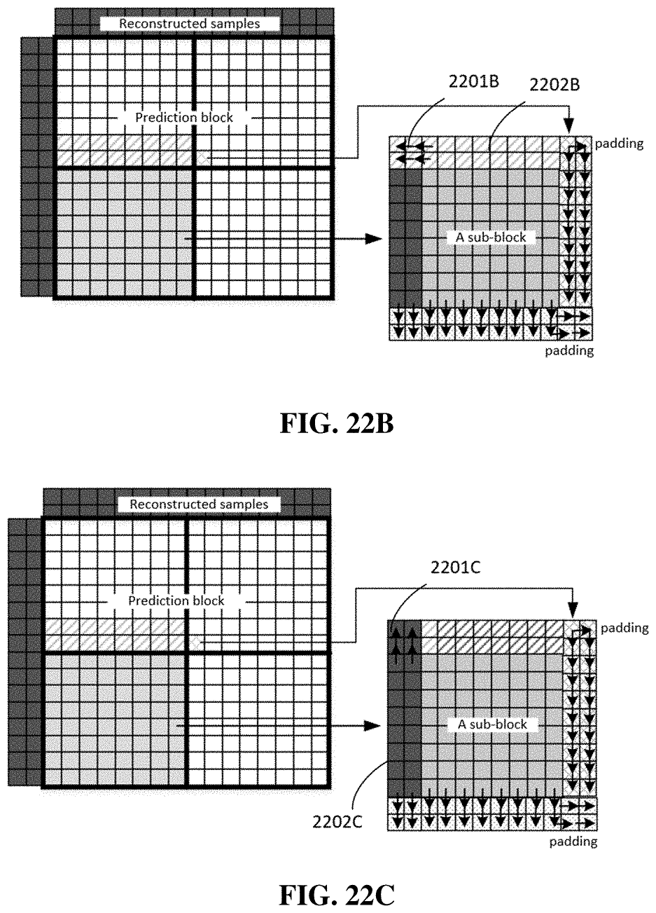

FIGS. 22A-22C illustrate another exemplary padding process for sub-block S, according to some embodiments of the present disclosure. As shown in FIG. 22A, a prediction block is split into four sub-blocks. Taking sub-block S in bottom-left of the prediction block for example, the right adjacent columns 2201A of the sub-block S are padded by a predicted sample X from the neighboring sub-blocks which is before the current block in the raster scan order. For the top adjacent rows 2202A of the sub-block, which is not adjacent to the top or left boundary of the prediction block, the adjacent predicted samples from the adjacent sub-blocks are saved to be used for filtering. The left adjacent columns 2203A and the adjacent corner 2206A are filled by the reconstructed samples. The bottom adjacent rows 2204A and the adjacent corner 2205A are obtained by padding from the current sub-block or saved samples. In some embodiments, as shown in FIG. 22B, the adjacent corner 2201B is obtained by padding from the saved samples 2202B. In some embodiments, as shown in FIG. 22C, the adjacent corner 2201C is obtained by padding from the reconstructed samples 2202C.

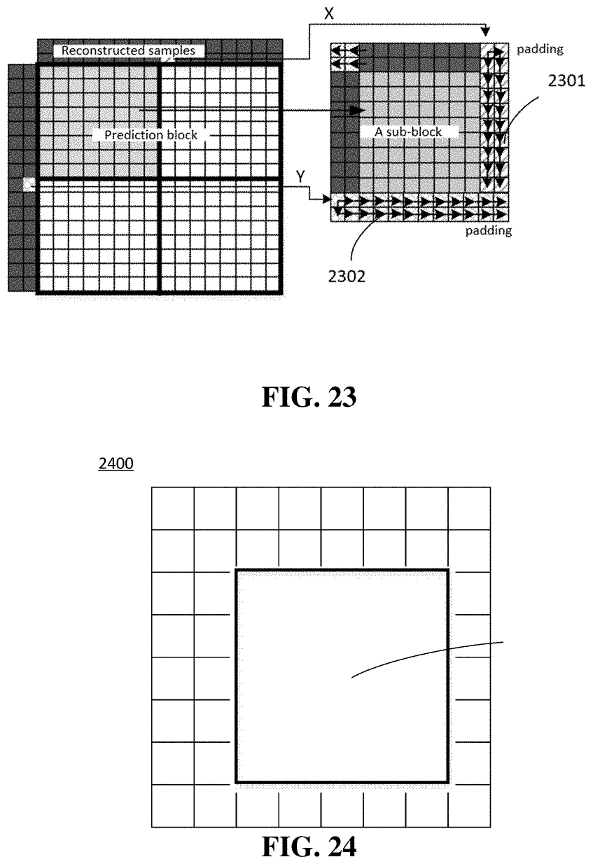

In some embodiments, some of the adjacent rows, columns and corners of each sub-block used for IPS can be padded by the adjacent reconstructed samples of the prediction block. FIG. 23 illustrates another exemplary padding process for sub-block, according to some embodiments of the present disclosure. As shown in FIG. 23, for a sub-block, the adjacent right columns 2301 and bottom rows 2302 can be padded by two reconstructed samples X and Y. In addition, the positions of the reconstructed samples used can be different for different intra prediction modes or different position of the current sub-block.

In some embodiments, different adjacent rows, columns and corners of a sub-block used for IPS can be obtained by using different methods as described above. Moreover, the methods can be based on the intra prediction mode and/or the position of the current sub-block.

In addition, the numbers of the padded rows and columns are depending on the number of the filter taps and the shape of the filter used for the prediction block.

Some embodiments of the present disclosure can modify or remove the restriction that only the blocks with the number of samples greater than or equal to 64 and less than 4096 can apply IPS. Furthermore, a decision on whether to apply the IPS or not can be made according to the width and the height of the block.

For example, the IPS is only applied to luminance intra prediction blocks with the number of samples is greater than or equal to 64 and less than or equal to 4096. Therefore, a prediction block with a number of samples being equal to 4096 can also apply IPS.

In some embodiments, the IPS is only applied to luminance intra prediction blocks with both the width and the height are greater than or equal to 8 and less than or equal to 64.

FIG. 24 is an exemplary 25-tap filter 2400, according to some embodiments of the present disclosure. As shown in FIG. 24, in conventional IPS design, when filtering one predicted sample, the sample X to be filtered is placed at the center of the filter. The predicted sample is multiplied by the weight in the center of the filter (e.g., 124), and the surrounding 24 samples are multiplied by the corresponding weights. In this way, all the samples in the left, right, above and bottom of the current sample are used for filtering.

In some embodiments, a one-side filter can be used to perform IPS, where the bottom-right weight is used for the current predicted sample when performing the IPS. In this way, only the samples in the left and above of the current predicted sample are used for filtering, which can solve the latency problem.

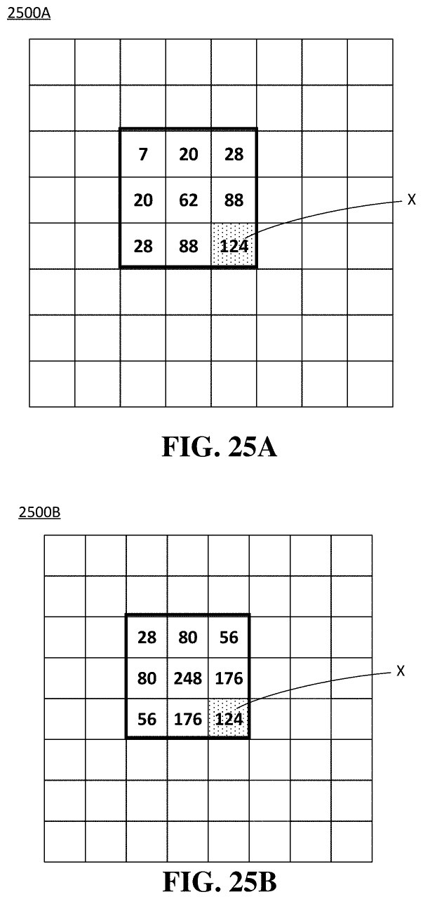

In some embodiments, the 25-tap filter described above is cropped to get a 9-tap filter to be used in IPS. FIG. 25A illustrates an exemplary 9-tap filter 2500A, according to some embodiments of the present disclosure. As shown in FIG. 25A, the top-left 9 taps of the 25-tap filter 2400 are selected as a 9-tap one-side filter 2500A. The current predicted sample X is multiplied by the weight in the bottom right of the filter (e.g., 124), and the other 8 samples in the left and above of the current sample are multiplied by the corresponding weights. This can reduce the multiples and adds and reduce the latency.

FIG. 25B illustrates another exemplary 9-tap one-side filter 2500B, according to some embodiments of the present disclosure. As shown in FIG. 25B, a 9-tap one-side filter 2500B is derived from the 25-tap filter 2400 by folding the 25-tap filter 2400 twice (e.g., up and down, then left and right), and adding the weights of the corresponding positions. Then the current predicted sample X is multiplied by the weight in the bottom right of the filter (e.g., 124), and the other 8 samples in the left and above of the current sample are multiplied by the corresponding weights.

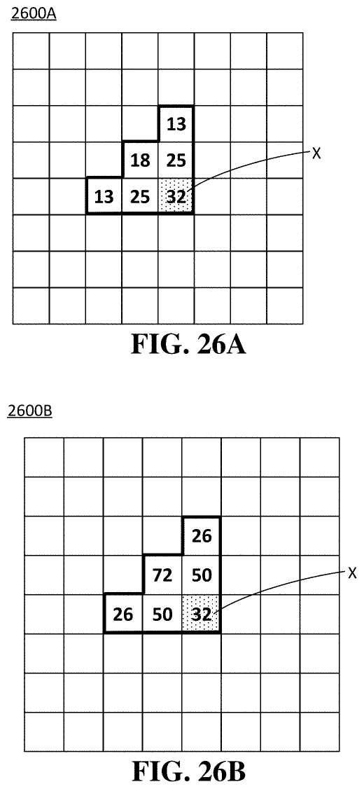

In some embodiments, the 13-tap filter (e.g., 13-tap filter 600 in FIG. 6) is cropped to get a 6-tap filter to be used in IPS. FIG. 26A illustrates an exemplary 6-tap one-side filter 2600A, according to some embodiments of the present disclosure. As shown in FIG. 26A, the current predicted sample X is multiplied by the weight in the bottom right of the filter (e.g., 32), and the other 5 samples in the left and above of the current sample are multiplied by the corresponding weights.

FIG. 26B illustrates another exemplary 6-tap one-side filter 2600B, according to some embodiments of the present disclosure. As shown in FIG. 26B, a 6-tap one-side filter 2600B is derived from the 13-tap filter 600 by folding the 13-tap filter 600 twice (e.g., up and down, then left and right), and adding the weights of the corresponding positions. Then the current predicted sample X is multiplied by the weight in the bottom right of the filter (e.g., 32), and the other 5 samples in the left and above of the current sample are multiplied by the corresponding weights.

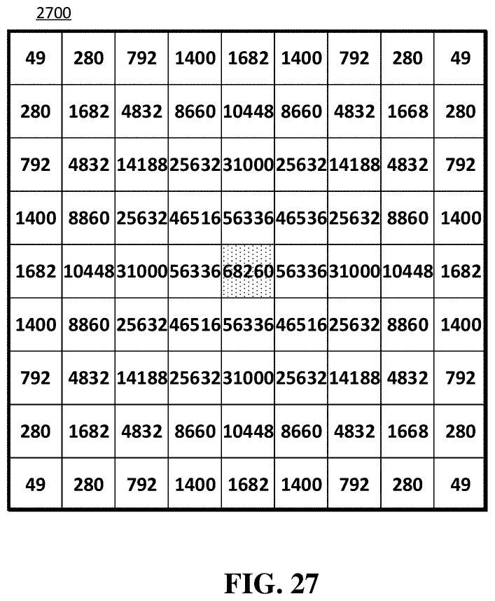

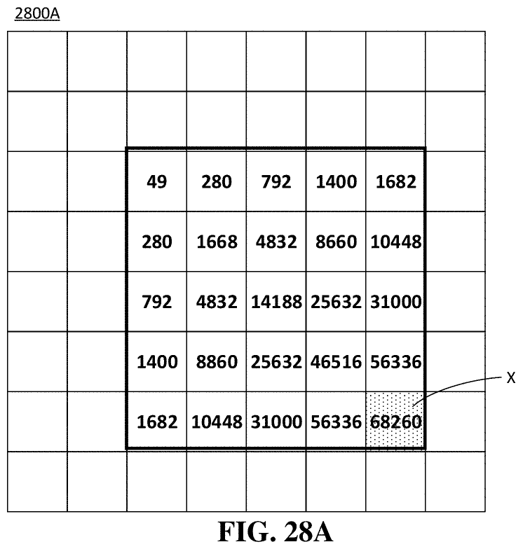

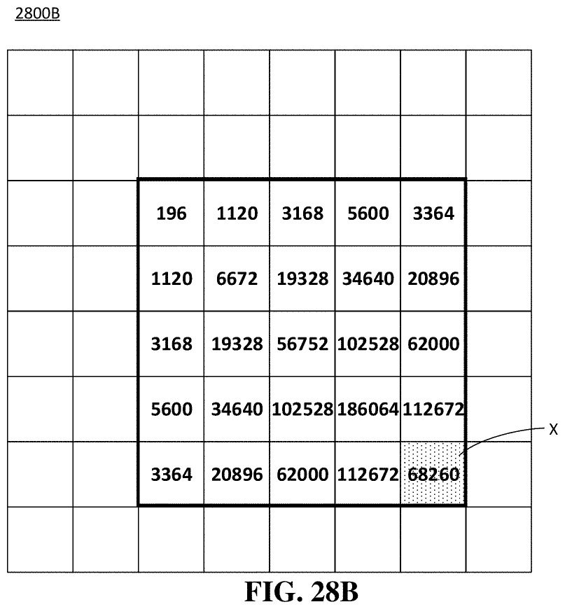

In some embodiments, another 25-tap filter is designed to be used in IPS. FIG. 27 illustrates an exemplary 81-tap filter 2700, according to some embodiments of the present disclosure. FIG. 28A illustrates an exemplary 25-tap filter 2800A, according to some embodiments of the present disclosure. As shown in FIG. 28A, the top-left 25 taps of the 81-taps filter 2700 are selected as a 25-tap one-side filter 2800A. The current predicted sample X is multiplied by the weight in the bottom right of the filter (e.g., 68260), and the other 24 samples in the left and above of the current sample are multiplied by the corresponding weights.

FIG. 28B illustrates another exemplary 25-tap one-side filter 2800B, according to some embodiments of the present disclosure. As shown in FIG. 28B, a 25-tap one-side filter 2800B is derived from the 81-tap filter 2700 by folding the 81-tap filter 2700 twice (e.g., up and down, then left and right), and adding the weights of the corresponding positions. Then the current predicted sample X is multiplied by the weight in the bottom right of the filter (e.g., 68260), and the other 24 samples in the left and above of the current sample are multiplied by the corresponding weights.

With a one-side filter, the multiples and adds can be reduced, and the latency is improved.

In some embodiments, some rows can be skipped when performing IPS for a prediction block.

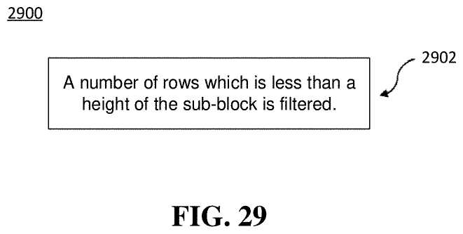

FIG. 29 illustrates a flow-chart of an exemplary method 2900 for improving IPS, according to some embodiments of the present disclosure. It is appreciated that method 2900 can be part of step 1608 in method 1600 of FIG. 16. In some embodiment, the method 2900 may further include the following step 2902.

At step 2902, a number of rows which is less than a height of the sub-block is filtered. Filtering less rows rather than filtering all the rows can reduce the latency.

For example, only the first Xrows of the prediction block or sub-block are filtered and the other rows are unfiltered.

In some embodiments, Xis equal to H-2, where H is the number of rows of the height of the prediction block or sub-block. Then, the IPS is only applied to the first H-2 rows of the prediction block. In addition, X can be any non-negative integer value less than H.

Conventionally, the IPS is performed with a 13-tap filter or a 25-tap filter. In some embodiments, the number of taps can be reduced to decrease the computational complexity and the buffering. Furthermore, reducing the tap in vertical direction can solve the latency issue.

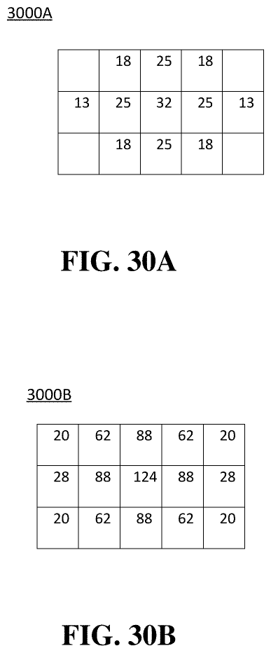

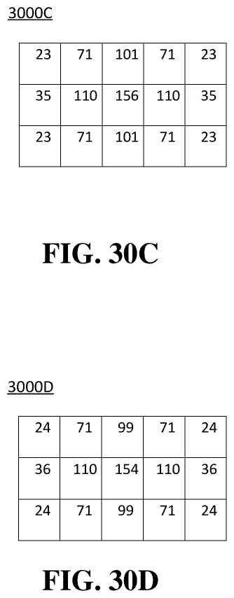

FIGS. 30A-30D illustrate exemplary cropped filters 3000A-3000D respectively, according to some embodiments of the present disclosure. As shown in FIG. 30A, a 13-tap filter (e.g., 13-tap filter 600 in FIG. 6) is cropped to a 11-tap filter 3000A by removing the top row and bottom row of the 13-tap filter 600. As shown in FIG. 30B, a 25-tap filter (e.g., 25-tap filter 700 in FIG. 7) is cropped to a 15-tap filter 3000B by removing the top row and bottom row of the 25-tap filter 700. FIG. 30C illustrates another exemplary cropped 15-tap filter 2900C, according to some embodiments of the present disclosure. FIG. 30D illustrates another exemplary cropped 15-tap filter 3000D, according to some embodiments of the present disclosure.

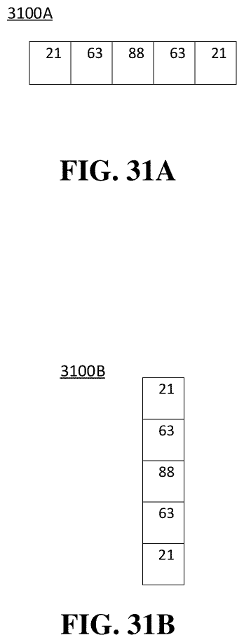

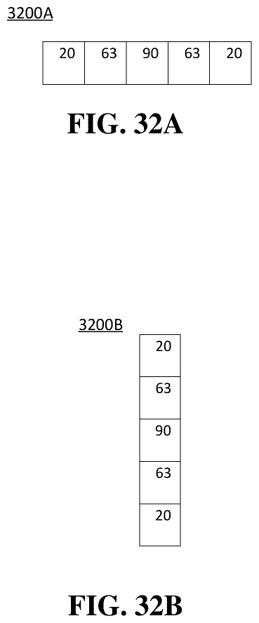

Conventionally, the IPS filters are 2D filters. In some embodiments, a 1D filter can be used to replace the 2D filter, so that the computational complexity, the hardware pipeline latency and the buffering can be reduced. The number of the taps can be any non-negative odd integer value, and each weight is a non-negative integer value. FIG. 31A illustrates an exemplary horizontal 1D 5-tap filter 3100A, according to some embodiments of the present disclosure. FIG. 31B illustrates an exemplary vertical 1D 5-tap filter 3100B, according to some embodiments of the present disclosure. FIG. 32A illustrates another exemplary horizontal 1D 5-tap filter 3200A, according to some embodiments of the present disclosure. FIG. 32B illustrates another exemplary vertical 1D 5-tap filter 3200B, according to some embodiments of the present disclosure.

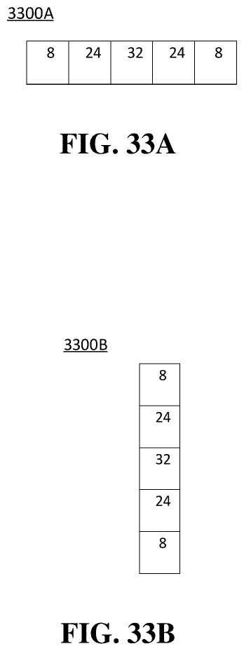

FIG. 33A and 33B illustrate another exemplary tow 1D 5-tap filters 3300A and 3300B respectively, according to some embodiment of the present disclosure. As shown in FIG. 33A and 33B, each weight value of the filter 3300A and 3300B is powers of 2 or can be represented by the sum of several numbers of powers of 2, for example 24=16+8.

In some embodiments, the filter design may have one of following characteristics, which can reduce the computation complexity:
1. the sum of weights is a number of power of 2 so that the multiplication can be replaced with shift operation (e.g., filters 3100A and 3100B).
2. each weight value is a number of power of 2 or a sum of several numbers of power of 2 (e.g., filters 3300A and 3300B).
3. the weights are horizontal and/or vertical symmetric. Therefore, the number of multiplications can be reduced (e.g., filters 3000A-3000D).

In some embodiments, a horizontal 1D filter and a vertical 1D filter are both used for performing IPS filtering. For example, horizontal filtering can be performed on all samples in the current prediction block with a horizontal 1D filter, and then vertical filtering can be performed on all the filtered samples with a vertical 1D filter. In some embodiments, vertical filtering can be performed on all samples in the current prediction block with a vertical 1D filter, and then horizontal filtering can be performed on all the filtered samples with a horizontal 1D filter.

In some embodiments, only horizontal filtering is performed on all samples in the current prediction block with a horizontal 1D filter.

In some embodiments, only vertical filtering is performed on all samples in the current prediction block with a vertical 1D filter.

In some embodiments, to use one of or both of horizontal 1D filter and vertical 1D filter or not use filter is determined according to the intra prediction mode used for the prediction blocks.

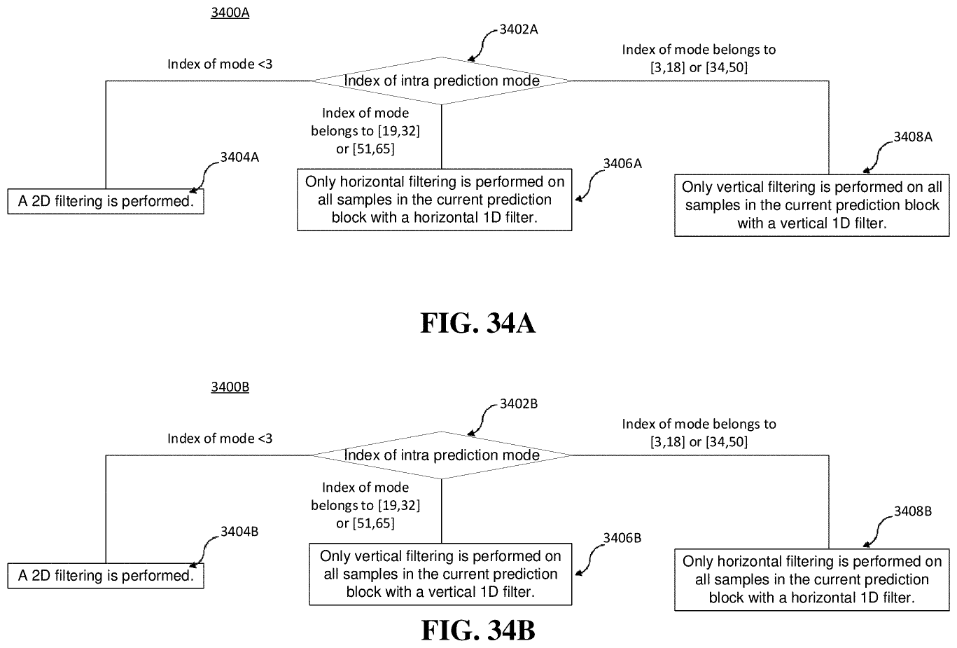

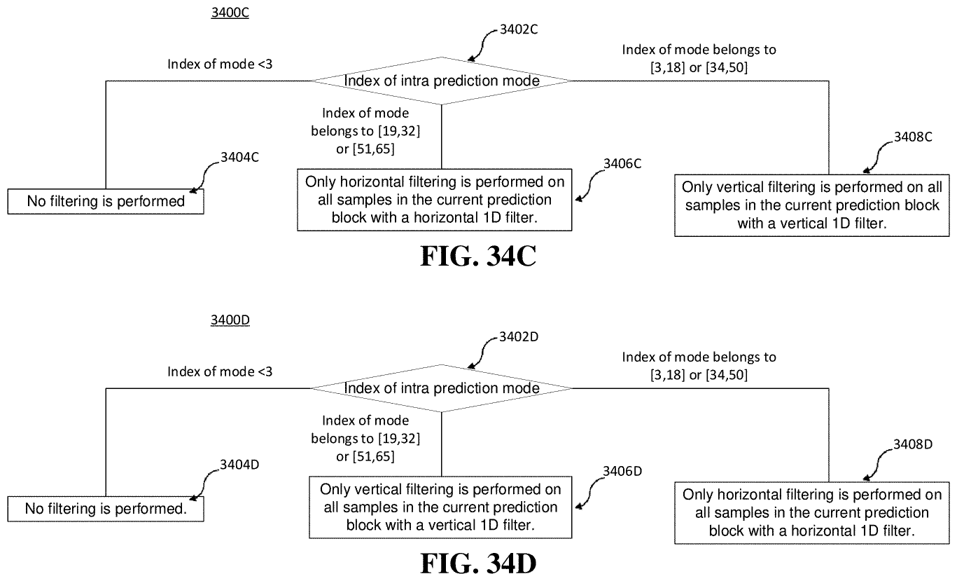

FIG. 34A illustrates a first exemplary flow-chart for the selection of the filters, according to some embodiments of the present disclosure. As shown in FIG. 34A, the selection of the filters is as follows:

At step 3402A, an index of intra prediction mode is determined.

At step 3404A, in response to the index of mode being less than 3 (e.g., a non-angular mode, such as Plane, Bilinear or DC mode), a 2D filtering is performed (horizontal first and vertical second or vertical first and horizontal second).

At step 3406A, in response to the index of mode ∈ [19,32] or [51,65] (e.g., the angular mode in the right of mode 18, referring to FIG. 11), only horizontal filtering is performed on all samples in the current prediction block with a horizontal 1D filter.

At step 3408A, in response to the index of mode ∈ [3,18] or [34,50] (e.g., the angular mode in the left of mode 18, referring to FIG. 11), only vertical filtering is performed on all samples in the current prediction block with a vertical 1D filter.

FIG. 34B illustrates a second exemplary flow-chart for the selection of the filters, according to some embodiments of the present disclosure. As shown in FIG. 34B, the selection of the filters is as follows:

At step 3402B, an index of intra prediction mode is determined.

At step 3404B, in response to the index of mode being less than 3 (e.g., a non-angular mode, such as Plane, Bilinear or DC mode), 2D filtering (horizontal first and vertical second or vertical first and horizontal second) is performed.

At step 3406B, in response to the index of mode ∈ [19,32] or [51,65] (e.g., the angular mode in the right of mode 18, referring to FIG. 11), only vertical filtering is performed on all samples in the current prediction block with a vertical 1D filter.

At step 3408B, in response to the index of mode ∈ [3,18] or [34,50] (e.g., the angular mode in the left of mode 18, including model 18, referring to FIG. 11), only horizontal filtering is performed on all samples in the current prediction block with a horizontal 1D filter.

FIG. 34C illustrates a third exemplary flow-chart for the selection of the filters, according to some embodiments of the present disclosure. As shown in FIG. 34C, the selection of the filters is as follows:

At step 3402C, an index of intra prediction mode is determined.

At step 3404C, in response to the index of mode being less than 3 (e.g., a non-angular mode, such as Plane, Bilinear or DC mode), no filtering is performed.

At step 3406C, in response to the index of mode ∈ [19,32] or [51,65] (e.g., the angular mode in the right of mode 18, referring to FIG. 11), only horizontal filtering is performed on all samples in the current prediction block with the proposed horizontal 1D filter.

At step 3408C, in response to the index of mode ∈ [3,18] or [34,50] (e.g., the angular mode in the left of mode 18, including mode 18, referring to FIG. 11), only vertical filtering is performed on all samples in the current prediction block with the proposed vertical 1D filter.

FIG. 34D illustrates a fourth exemplary flow-chart for the selection of the filters, according to some embodiments of the present disclosure. As shown in FIG. 34D, the selection of the filters is as follows:

At step 3402D, an index of intra prediction mode is determined.

At step 3404D, in response to the index of mode being less than 3 (e.g., a non-angular mode, such as Plane, Bilinear or DC mode), no filtering is performed.

At step 3406D, in response to the index of mode ∈ [19,32] or [51,65] (e.g., the angular mode in the right of mode 18, referring to FIG. 11), only vertical filtering is performed on all samples in the current prediction block with a vertical 1D filter.

At step 3408D, in response to the index of mode ∈ [3,18] or [34,50] (e.g., the angular mode in the left of mode 18, including mode 18, referring to FIG. 11), only horizontal filtering is performed on all samples in the current prediction block with a horizontal 1D filter.

In some embodiments, when performing IPS filtering, it is determined, according to the intra prediction mode, to use a 1D horizontal filter with different weights. For example, for vertical modes, a shaper 1D horizontal filter (the differences of weights are large) is used. For horizontal modes, a smoother 1D horizontal filter (the differences of weights are small) is used.

In some embodiment, the weights in the horizontal 1D filter and the vertical 1D filter can be different. In some embodiments, the tap number of 1D horizontal filter may be different from the tap number of 1D vertical filter. To reduce the memory cost and latency, 1D vertical filter may have less tap number than 1D horizontal filter. For example, 1D horizontal filter has 5 taps, while 1D vertical filter only has 3 taps.

The present disclosure also proposes to use a 1D horizontal filter for the padded prediction block and combine with some reference samples. In this way, the hardware pipeline latency and the buffering can be reduced.

In some embodiments, when filtering the current prediction filter with a 1D horizontal filter, some reference samples from top reference row and left reference column at the corresponding positions can be used.

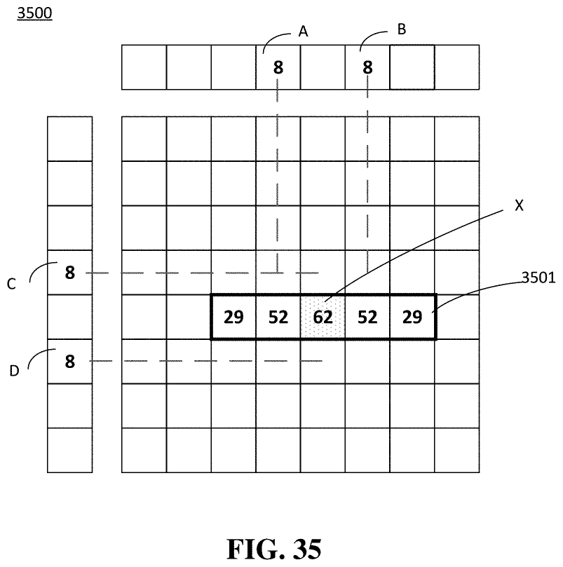

FIG. 35 illustrates an exemplary 5+4 tap filter 3500, according to some embodiments of the present disclosure. As shown in FIG. 35, a 5+4 tap filter 3500 may be used. The internal 1D horizontal 5 tap filter 3501 is used for the padded prediction block and the external 4 weights (e.g., 8) are used for the 4 reference samples (A-D) at the corresponding positions. Therefore, only two columns in each side need to be padded. When filtering the current sample X, the used reference samples are: two samples (A and B) with coordinates in the top reference row, the sample coordinates being equal to the current sample X horizontal coordinate minus 1 and plus 1, respectively; and two samples (C and D) with coordinates in the left reference column, the sample coordinates being equal to the current sample X vertical coordinate minus 1 and plus 1, respectively.

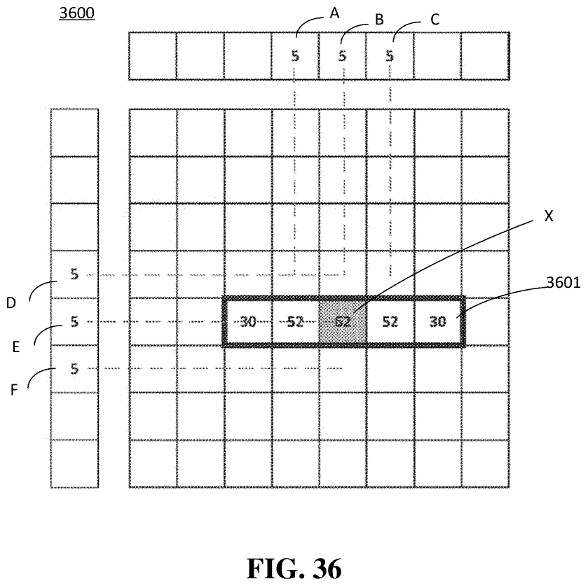

FIG. 36 illustrates an exemplary 5+6 tap filter 3600, according to some embodiments of the present disclosure. As shown in FIG. 36, the internal 1D horizontal 5 tap filter 3501 is used for the padded prediction block and the external 6 weights (e.g., 5) are used for the 6 reference samples (A-F) at the corresponding positions. When filtering the current sample X, the used reference samples are: three samples with coordinates A-C in the top reference row, the sample coordinates being equal to the current sample horizontal coordinate, the current sample horizontal coordinate minus 1 and plus 1, respectively; and three samples with coordinates in the left reference column D-F, the sample coordinates being equal to the current sample X vertical coordinate, the current sample X vertical coordinate minus 1 and plus 1, respectively.

In some embodiments, only some reference samples from left reference column at the corresponding positions are used.

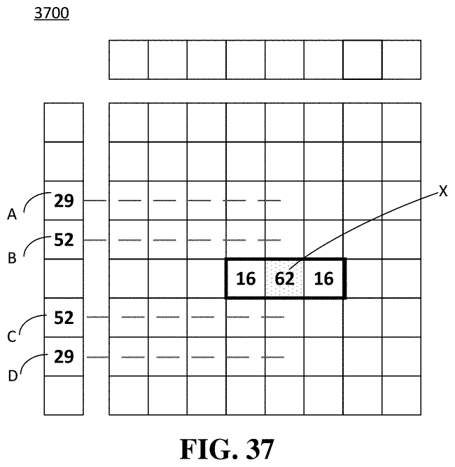

FIG. 37 illustrates an exemplary 3+4 tap filter 3700, according to some embodiments of the present disclosure. As shown in FIG. 37, the used reference samples are four samples with coordinates in the left reference column (A -D), the sample coordinates being equal to the current sample X vertical coordinate minus 1, minus 2, plus 1 and plus 2, respectively.

In some embodiments, some reference samples at the corresponding positions are averaged to use for the filter process.

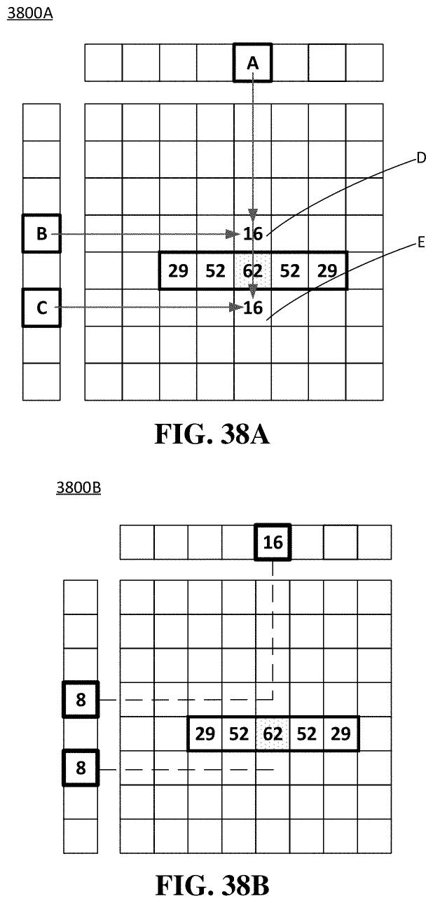

FIG. 38A illustrates an exemplary 5+2 tap filter 3800A, according to some embodiments of the present disclosure. As shown in FIG. 38A, the two external weights (e.g., 16) are multiplied by two average reference samples. The top average reference sample D is the average of the marked sample A in the top reference row and the first marked sample B in the left reference column. The bottom average reference sample E is the average of the marked sample A in the top reference row and the second marked sample B in the left reference column.

FIG. 38B illustrates an exemplary 5+3 tap filter 3800B, according to some embodiments of the present disclosure. The filter 3800B shown in FIG. 38B and the filter 3800A show in FIG. 38A can perform a same IPS.

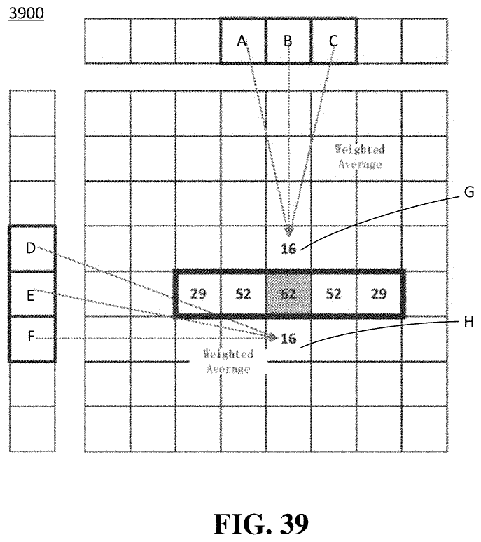

FIG. 39 illustrates another exemplary 5+2 tap filter 3900, according to some embodiments of the present disclosure. As shown in FIG. 39, the two external weights (e.g., 16) are multiplied by two averaged reference samples. Each averaged sample is obtained by the weighted average of the three reference samples shown in FIG. 39 with weight coefficient of [1, 2, 1]. For example, the top averaged sample G is obtained by the weighted average of the three reference samples A-C in the top reference row, with weight coefficient of [1, 2, 1] corresponding to A, B and C. The bottom average reference sample H is obtained by the weighted average of the three reference samples D-F in the left reference column, with weight coefficient of [1, 2, 1] corresponding to D, E and F.

In some embodiments, the reference samples at the corresponding positions according to the intra prediction mode are used for the filter process. If the prediction mode is a non-angular mode, the averaged reference samples are used. If the prediction mode is an angular mode, the reference samples according to the prediction direction are used.

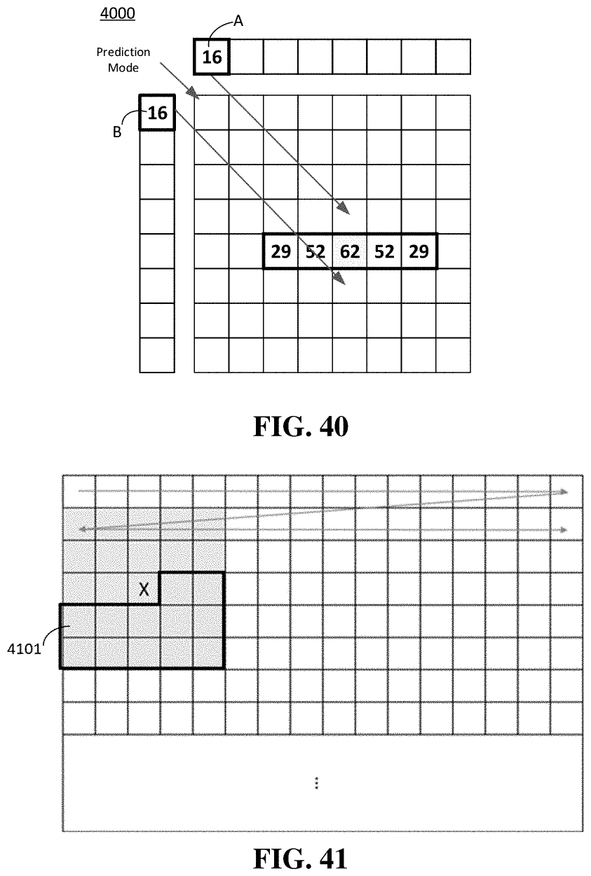

FIG. 40 illustrates another exemplary 5+2 tap filter 4000, according to some embodiments of the present disclosure. As shown in FIG. 40, if the prediction mode is an angular mode (e.g., mode 18), the two external weights (e.g., 16) are multiplied by two reference samples (A and B), according to the prediction direction.

The number of the taps of the internal 1D horizontal used for the padded prediction block can be any positive integer, such as 3, 5, 7 and 9. The number of the used reference samples can be any positive integer, such as 2 and 4.

In some embodiments, the filter can be applied to not only the luma samples but also chroma samples. Therefore, the benefits of smoothing the prediction boundaries between prediction samples can be applied to chroma. In some embodiments, the filter used for chroma samples may be the same as the one used for luma samples. In some embodiments, the filter used for chroma samples may have less tap than the one used for luma samples. In some embodiments, the filter used for chroma samples may be sub-sampled from the one used for luma samples.

Conventionally, a prediction sample is filtered by surrounding prediction samples of the prediction sample. Due to the order of predicting samples, the latency issue is thus introduced. In some embodiments, reference sample can be used instead of prediction sample when performing filtering. FIG. 41 is a schematic diagram illustrating an exemplary intra prediction filtering with reference samples, according to some embodiments of the present disclosure. As shown in FIG. 41, the samples at bottom right 4101 of sample X are not predicted yet. Therefore, the samples 4101 are replaced with reference samples when performing filtering.

In some embodiments, the reference samples used to replace the prediction samples may be the left or top reference samples.

In some embodiments, the reference samples used to replace the prediction samples may depend on intra prediction direction.

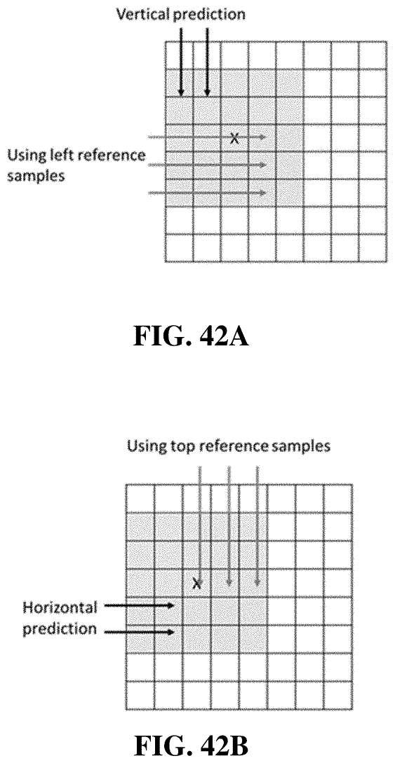

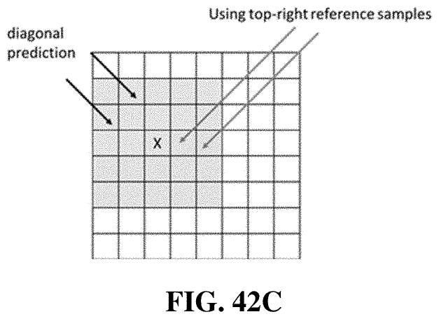

FIGS. 42A-42C illustrate exemplary intra prediction filtering with reference samples in different directions, according to some embodiments of the present disclosure. As shown in FIGS. 41A-42C, the reference samples used are orthogonal to the intra prediction direction. For another example, the reference samples used are parallel to the intra prediction direction.

In some embodiments, the reference samples used to replace the prediction samples may depend on the block shape. If the block is flat-and-wide, the top reference samples are used. If the block is tall-and-narrow, the left reference samples are used.

Conventionally, when filtering the current sample, each weight in the filter needs to be multiplied by a corresponding sample, and the sum of the products needs to be divided by the sum of all the weights in the filter. The present disclosure proposes methods to enlarge or reduce the filter.

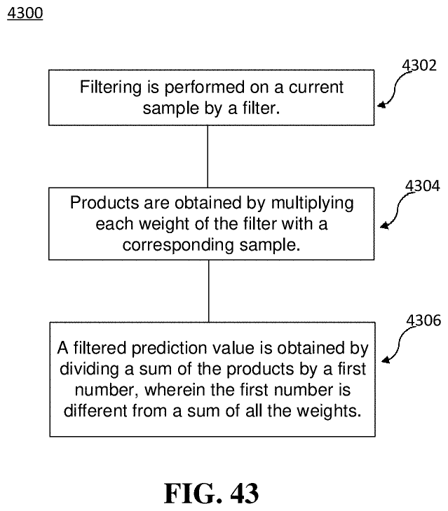

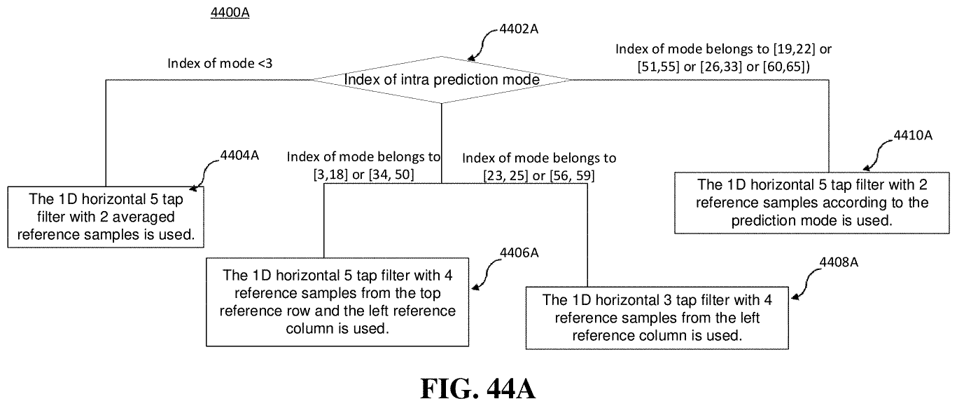

FIG. 43 illustrates a flow-chart of an exemplary method 4300 for improving IPS, according to some embodiments of the present disclosure. It is appreciated that method 4300 can be part of step 1608 in method 1600 of FIG. 16. In some embodiment, the method 4300 may further include the following steps 4302-4306.

At step 4302, filtering is performed on a current sample by a filter.

At step 4304, products are obtained by multiplying each weight of the filter with a corresponding sample.

At step 4306, a filtered prediction value is obtained by dividing a sum of the products by a first number, wherein the first number is different from a sum of all the weights.

In some embodiments, the sum of the products can be divided by a number that is less than the sum of all the weights. For example, if the sum of all the weights is 254, the sum of the multiplications can be divided by 256.

In some embodiments, the sum of the products can be divided by a number that is greater than the sum of all the weights. For example, if the sum of all the weights is 258, the sum of the multiplications can be divided by 256.

In some embodiments, the filtered prediction values obtained by IPS can further be multiplied by a reduced factor with value less than 1. For example, the reduced factor can be equal to 254/256 or 252/256.

In some embodiments, the filtered prediction values obtained by IPS can further be multiplied by an enlarged factor with value greater than 1. For example, the enlarged factor can be equal to 258/256 or 260/256.

In the present disclosure, various filters are proposed. The differences between these filters are different numbers of filter taps, different filter shapes, different filter dimensions, different values of the filter weights, and different reference samples used for the filter.

In some embodiments, two or more filters can be used for IPS. The filters with the minimum rate-distortion cost will be selected in encoder. And additional flag(s) are signaled to indicate which filter is used.

In some embodiments, two or more filters can be used for IPS. And the filters can be selected adaptively according to the prediction mode.

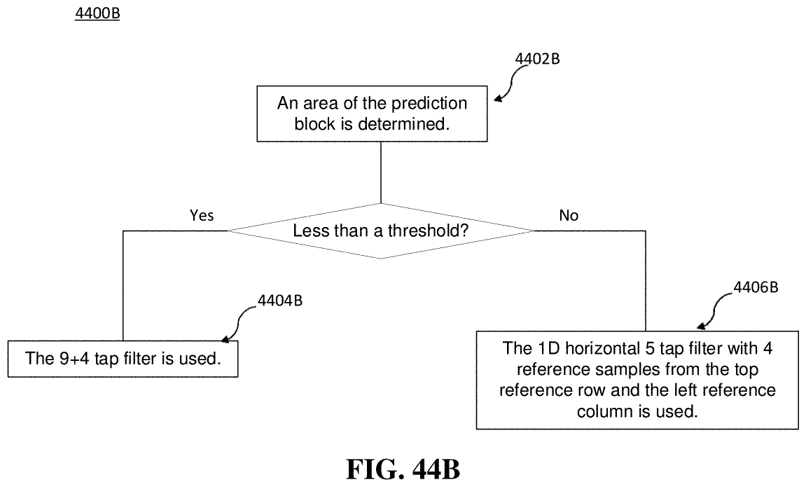

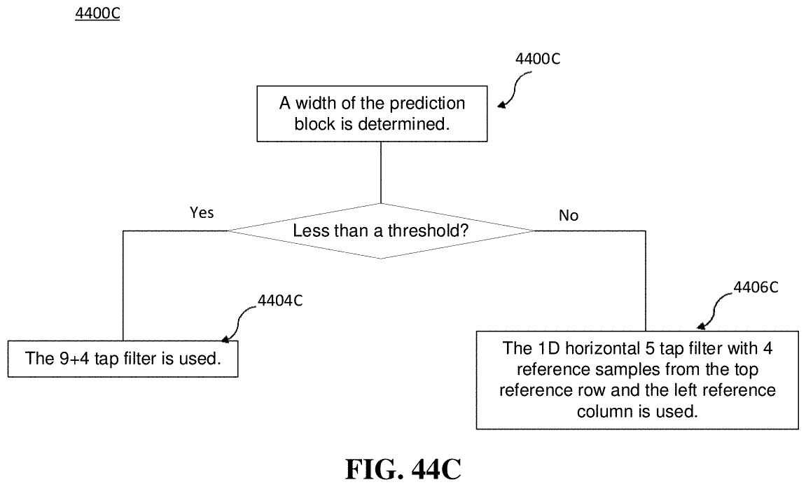

FIG. 44A illustrates an exemplary flow-chart for selection of the filters, according to some embodiments of the present disclosure. For example, the prediction modes are divided into several different sets, the selection of the filter for each set is as follows:

At step 4402A, an index of intra prediction mode is determined.

At step 4404A, in response to the index of mode being less than 3 (e.g., non-angular modes, such as Plane, Bilinear and DC modes), the 1D horizontal 5 tap filter with 2 averaged reference samples as shown in FIG. 38A is used.

At step 4406A, in response to the index of mode ∈ [3,18] or [34,50] (e.g., the angular mode in the left of mode 18, referring to FIG. 11), the 1D horizontal 5 tap filter with 4 reference samples from the top reference row and the left reference column as shown in FIG. 35 is used.

At step 4408A, in response to the index of mode ∈ [23,25] or [56,59] (e.g., the angular mode around the horizontal direction, referring to FIG. 11), the 1D horizontal 3 tap filter with 4 reference samples from the left reference column as shown in FIG. 37 is used.

At step 4410A, in response to the index of mode ∈ [19,22] or [51,55] or [26,33] or [60,65]), the 1D horizontal 5 tap filter with 2 reference samples according to the prediction mode as shown in FIG. 40 is used.

In some embodiments, the filters can be selected adaptively according to the area of the prediction block.

FIG. 44B illustrates another exemplary flow-chart for selection of the filters, according to some embodiments of the present disclosure. For example, the selection of the filters is as follows:

At step 4402B, an area of the prediction block is determined.

At step 4404B, in response to the area of the prediction block is less than a threshold (e.g., 1024), the 9+4 tap filter as shown in FIG. 8 is used.

At step 4406B, in response to the other prediction blocks, the 1D horizontal 5 tap filter with 4 reference samples from the top reference row and the left reference column as shown in FIG. 35 is used.

For another example, the selection of the filters is as follows:

For the area of the prediction block is greater than a threshold (e.g., 1024), the 9+4 tap filter as shown in FIG. 8 is used.

For other prediction blocks, the 1D horizontal 5 tap filter with 4 reference samples from the top reference row and the left reference column as shown in FIG. 35 are used.

In some embodiments, the filters can be selected adaptively according to the width of the prediction block.

FIG. 44C illustrates another exemplary flow-chart for selection of the filters, according to some embodiments of the present disclosure. For example, the selection of the filters is as follows:

At step 4402C, a width of the prediction block is determined.

At step 4404C, in response to the width of the prediction block is less than a threshold (e.g., 16), the 9+4 tap filter as shown in FIG. 8 is used.

At step 4406C, in response to other prediction blocks, the 1D horizontal 5 tap filter with 4 reference samples from the top reference row and the left reference column as shown in FIG. 35 is used.

For another example, the selection of the filters is as follows:

For the width of the prediction block is greater than a threshold (e.g., 16), the 9+4 tap filter as shown in FIG. 8 is used.

For other prediction blocks, the 1D horizontal 5 tap filter with 4 reference samples from the top reference row and the left reference column as shown in FIG. 35 is used.

One or more embodiments of the present disclosure can be combined with other one or more embodiments. For example, a W×H prediction block can be vertically divided into several M×H sub-blocks, and 1D horizontal filter can be applied to each prediction sample. For another example, a W x H prediction block can be vertically divided into several M×H sub-blocks, and 5×3 tap filter can be applied to each prediction sample.

The InterPF method generates the final prediction block by weighting two prediction blocks Pred_inter and Pred_Q. The Pred_inter is derived by inter prediction. The Pred_Q is derived by the reconstructed reference samples of the current block like intra prediction.

In some embodiments, IPS can be applied to InterPF. For example, the IPS can be performed to the final prediction block obtained by InterPF. In some embodiments, the IPS can be only performed to the Pred_Q(x,y) when the InterPF index is equal to 0. For example, the aforementioned 25-tap IPS filter can be used to filter the Pred_Q. Therefore, the prediction accuracy is improved.

A two-step cross-component prediction mode (TSCPM) for chroma intra coding was adopted in AVS3, which assumes a linear correlation between luma and chroma components. When the chroma block utilizes cross-component prediction mode, two steps are required to get the chroma prediction block.

TSCPM can be performed in the following steps:
1) Getting linear model from neighboring reconstructed samples.
2) Applying the linear model to the originally reconstructed luma block to get an internal prediction block.
3) Down-sampling the internal prediction block to generate the final chroma prediction block.

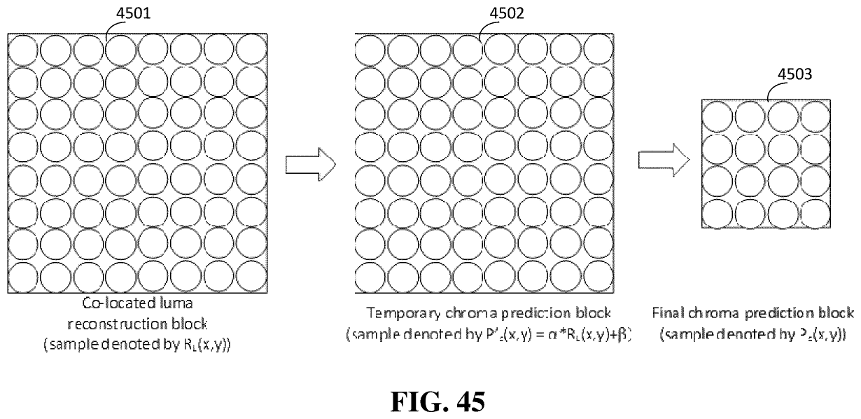

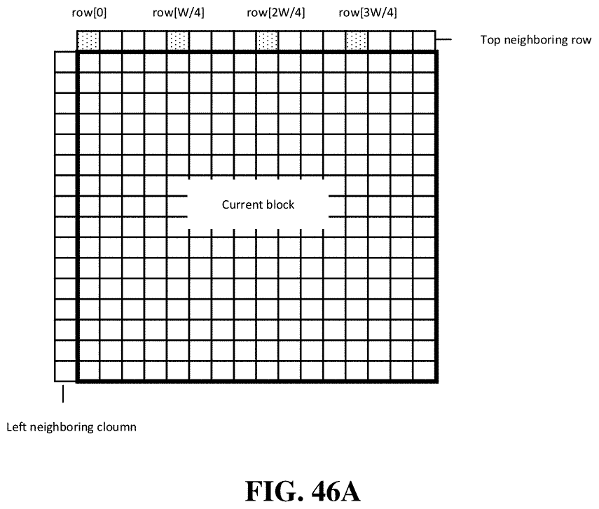

FIG. 45 is a schematic diagram illustrating an exemplary coding flow of TSCPM, according to some embodiments of the present disclosure. In FIG. 45, the chroma prediction block generation process is shown. The co-located luma reconstruction block 4501 denotes the originally reconstructed luma sample located at (x, y) of the collocated luma block by RL(x, y). By simply applying the linear model with parameters (a, (3) to each luma sample, a temporary chroma prediction block 4502 is generated. After that, the temporary chroma prediction block 4502 is further down-sampled to generate the final chroma prediction block 4503.

There are 3 TSCPM modes: TSCPM_LT, TSCPM_L and TSCPM_T modes. The difference between these three modes lies in the different samples selected to construct the linear model parameters. For a W×H block, using row[0, . . , W-1] to represent the reconstructed samples of the top neighboring row and using col[0, . . . ,H-1] to represent the reconstructed samples of the left neighboring column, the selected samples can be as follows:

For TSCPM_LT mode:
If both row[0, . . . , W-1] and col[0, . . . , H-1] are available and W is greater than or equal to H, the samples row[0], row[W-W/H], col[0] and col[H-1] are selected;
If both row[0, . . . , W-1] and col[0, . . . , H-1] are available and W is less than H, the samples row[0], row[W-1], col[0] and col[H-H/W] are selected;
If only row[0, . . . , W-1] are available, the samples row[0], row[W/4], row[2W/4] and row[3W/4] are selected;
If only col[0, . . . , W-1] are available, the samples col[0], col[H/4], col[2H/4] and col[3H/4] are selected;

For TSCPM_T mode:
The samples row[0], row[W/4], row[2W/4] and row[3W/4] are selected;

For TSCPM_L mode:
The samples col[0], col[H/4], col[2H/4] and col[3H/4] are selected.

The 4 selected samples are sorted according to luma sample intensity and classified into 2 group. The two larger samples and two smaller samples are respectively averaged. Cross component prediction model is derived with the 2 averaged points.

The temporary chroma prediction block is generated based on Eq. (14),

P_{c}′(x, y)=α×R_{L}(x, y)+β Eq. (14)

where P_{c}′ (x, y) denotes a temporary prediction sample of chroma, a and are two model parameters, and R_{L} (x, y) is a reconstructed luma sample.

Similar to normal intra prediction process, clipping operations are applied to P_{c}′ (x, y) to make sure it is within [0, 1«(BitDepth-1)].

A six-tap filter (e.g., [1 2 1; 1 2 1]) is introduced for the down-sampled process for temporary chroma prediction block, based on Eq. (15),

P_{c}=(2×P_{c}′(2x, 2y)+2×P_{c}′(2x, 2y+1)+P_{c}′(2x−1, 2y)+P_{c}′(2x+1, 2y)+P_{c}′(2x−1, 2y+1)+P_{c}′(2x+1, 2y−1)+4)»3 Eq. (15)

In addition, for chroma samples located at the left most column, [1 1] down-sampling filter is applied instead.

A prediction from multiple cross-components (PMC) method was adopted in AVS3 in which the predictors of Cr component are derived by a linear model of the reconstructed values of Y component and the reconstructed values of Cb component based on Eq. (16) and Eq. (17),

IPred=A·R_{L}+B Eq. (16)

FPred_{Cr}=IPred′−R_{Cb} Eq. (17)

where R_{L} denotes the reconstructed block of Y, IPred is an internal block that has the same dimension of luma coding block, IPred′ represents the down-sampled block from IPred which has the same dimension as chroma coding block, R_{Cb} denotes the reconstructed block of Cb, and FPred_{Cr} denotes the predicted block of Cr. A and B in Eq. (16) are two parameters of PMC model which is derived from the parameters of TSCPM based on Eq. (18) and Eq. (19),

A=α₀+α₁ Eq. (18)

B=β₀+β₁ Eq. (19)

where (α₀, (β₀) and (α₁,β₁) are two sets of linear model parameters derived for Cb and Cr in TSCPM. PMC also has three modes: PMC_LT, PMC_T and PMC_L. In these three modes, the sample positions selected when calculating the parameters (α₀, (β₀) and (α₁, β₁) can be the same as the three modes of TSCPM_LT, TSCPM_T, and TSCPM_L as described above, respectively.

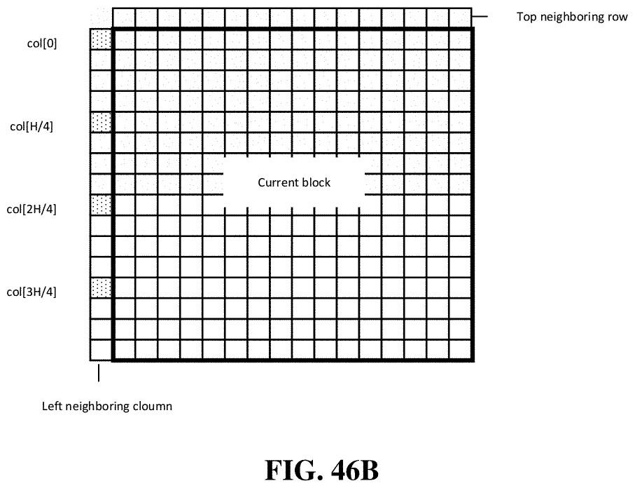

FIG. 46A illustrates exemplary selected samples for deriving the model parameters for TSCPM_T and PMC_T modes, according to some embodiments of the present disclosure. FIG. 46B illustrates exemplary selected samples for deriving the model parameters for TSCPM_L and PMC_L modes, according to some embodiments of the present disclosure. There may be some problems for the selected samples for deriving the model parameters as shown in FIG. 46A and FIG. 46B. For example, the selected samples for TSCPM_T and PMC_T modes are the same to those in TSCPM_LT and PMC-LT modes when only the top neighboring row is available. The selected samples for TSCPM_L and PMC_L modes are the same to those in TSCPM_LT and PMC-LT modes when only the left neighboring column is available. The selected samples for TSCPM_T and PMC_T modes are too close to the left boundary. The selected samples for TSCPM_L and PMC_L modes are too close to the top boundary. Therefore, the selected sample positions can be refined for TSCPM_T, PMC_T, TSCPM_L and PMC_L modes (e.g., the modes only use one reference side).

In some embodiments, an offset can be added when selecting the samples for TSCPM_T, PMC_T, TSCPM_L and PMC_L modes (e.g., the modes only use one reference side). For TSCPM_T and PMC_T modes, the selected positions are offset to the right by oW. For TSCPM_L and PMC_L modes, the selected positions are offset to the bottom by oH. The value of oW is greater than 0 and less than W/4. The value of oH is greater than 0 and less than H/4.

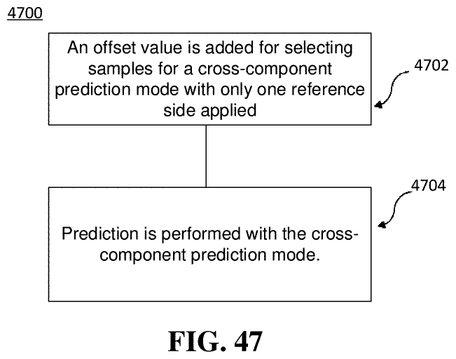

FIG. 47 illustrates a flow-chart of an exemplary method 4700 for selecting samples for deriving model parameters, according to some embodiments of the present disclosure. Method 4700 can be performed by an encoder (e.g., by process 200A of FIG. 2A or 200B of FIG. 2B) or performed by one or more software or hardware components of an apparatus (e.g., apparatus 400 of FIG. 4). For example, one or more processors (e.g., processor 402 of FIG. 4) can perform method 4700. In some embodiments, method 4700 can be implemented by a computer program product, embodied in a computer-readable medium, including computer-executable instructions, such as program code, executed by computers (e.g., apparatus 400 of FIG. 4). Referring to FIG. 47, method 4700 may include the following steps 4702 and 4704.

At step 4702, an offset value is added for selecting samples for a cross-component prediction mode with only one reference side applied. For example, the offset value could be W/8 or H/8, where W and H are the width and height of the prediction block.

At step 4704, prediction is performed with the cross-component prediction mode.

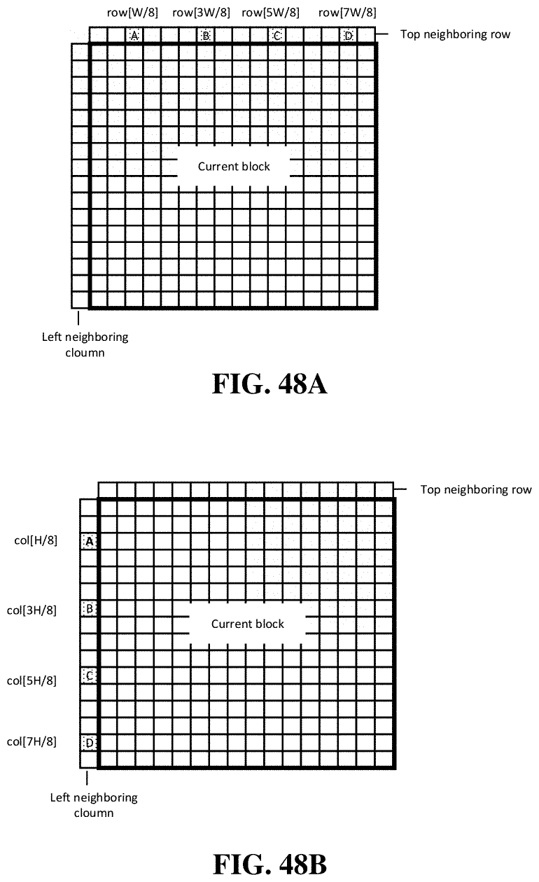

FIG. 48A and 48B illustrate exemplary selected samples for deriving the model parameters, according to some embodiments of the present disclosure. For example, oW is set equal to W/8 and off is set equal to H/8. As shown in FIG. 48A, for TSCPM_T and PMC_T modes, the selected samples A-D for deriving the model parameters are modified with offset rightward W/8 compared with the selected samples shown in FIG. 46A. As shown in FIG. 48B, for TSCPM_L and PMC_L mode, the selected samples A-D for deriving the model parameters are modified with offset downward H/8 compared with the selected samples shown in FIG. 46B.

In some embodiments, the offset can be only used for TSCPM_L and TSCPM_T modes. In some embodiments, the offset can be only used for PMC_L and PMC_T modes. In some embodiments, the offset can be used for TSCPM_L, TSCPM_T, PMC_L and PMC_T modes.

It is appreciated that, one of ordinary skill in the art can combine some of the described embodiments into one embodiment.

The embodiments may further be described using the following clauses:

1. A video processing method, comprising:
dividing an intra prediction block into one or more sub-blocks;
performing padding process for the one or more sub-blocks; and
filtering the one or more sub-blocks with a parallel intra prediction smoothing (IPS) process.

2. The method of clause 1, wherein filtering the one or more sub-blocks with the parallel IPS process comprises:
filtering the one or more sub-blocks with a one-dimensional (1D) filter.

3. The method of clause 2, further comprising:
determining whether to filter with the 1D filter based on an intra prediction mode used for the prediction block.

4. The method of clause 2 or 3, further comprising:
filtering the one or more sub-blocks with a 1D horizontal filter and one or more reference samples from a top reference row and/or one or more reference samples from a left reference column at a corresponding position.

5. The method of any one of clauses 1 to 4, wherein two or more filters are used for the parallel IPS process.

6. The method of clause 5, further comprising:
selecting the two or more filters based on minimum rate-distortion cost by an encoder; and
signaling one or more flags to indicate the two or more filters.

7. The method of clause 5, wherein the two or more filters are selected based on a prediction mode.

8. The method of any one of clauses 1 to 7, wherein the prediction block includes less than 64 samples or more than 4096 samples.

9. The method of any one of clauses 1 to 8, further comprising:
determining whether to perform the parallel IPS process based on a width and a height of the prediction block.

10. The method of any one of clauses 1 to 9, wherein the parallel IPS process is performed on a chroma sample.

11. An apparatus for video processing, the apparatus comprising:

a memory figured to store instructions; and

one or more processors configured to execute the instructions to cause the apparatus to perform:
dividing an intra prediction block into one or more sub-blocks;
performing padding process for the one or more sub-blocks; and
filtering the one or more sub-blocks with a parallel intra prediction smoothing (IPS) process.

12. The apparatus of clause 11, wherein the one or more processors are further configured to execute the instructions to cause the apparatus to perform:
filtering the one or more sub-blocks with a one-dimensional (1D) filter.

13. The apparatus of clause 12, wherein the one or more processors are further configured to execute the instructions to cause the apparatus to perform:

determining whether to filter with the 1D filter based on an intra prediction mode used for the prediction block.

14. The apparatus of clause 12 or 13, wherein the one or more processors are further configured to execute the instructions to cause the apparatus to perform:

filtering the one or more sub-blocks with a 1D horizontal filter and one or more reference samples from a top reference row and/or one or more reference samples from a left reference column at a corresponding position.

15. The apparatus of any one of clauses 11 to 14, wherein two or more filters are used for the parallel IPS process.

16. The apparatus of clause 15, wherein the one or more processors are further configured to execute the instructions to cause the apparatus to perform:

selecting the two or more filters based on minimum rate-distortion cost by an encoder; and

signaling one or more flags to indicate the two or more filters.

17. The apparatus of clause 15, wherein the two or more filters are selected based on a prediction mode.

18. The apparatus of any one of clauses 11 to 17, wherein the prediction block includes less than 64 samples or more than 4096 samples.

19. The apparatus of any one of clauses 11 to 18, wherein the one or more processors are further configured to execute the instructions to cause the apparatus to perform:
determining whether to perform the parallel IPS process based on a width and a height of the prediction block.

20. The apparatus of any one of clauses 11 to 19, wherein the one or more processors are further configured to execute the instructions to cause the apparatus to perform:
performing the parallel IPS process on a chroma sample.

21. A non-transitory computer readable medium that stores a set of instructions that is executable by one or more processors of an apparatus to cause the apparatus to initiate a method for video processing, the method comprising:
dividing an intra prediction block into one or more sub-blocks;
performing padding process for the one or more sub-blocks; and
filtering the one or more sub-blocks with a parallel intra prediction smoothing (IPS) process.

22. The non-transitory computer readable medium of clause 21, wherein the set of instructions that is executable by one or more processors of an apparatus to cause the apparatus to further perform:
filtering the one or more sub-blocks with a one-dimensional (1D) filter.

23. The non-transitory computer readable medium of clause 22, wherein the set of instructions that is executable by one or more processors of an apparatus to cause the apparatus to further perform:
determining whether to filter with the 1D filter based on an intra prediction mode used for the prediction block.

24. The non-transitory computer readable medium of clause 22 or 23, wherein the set of instructions that is executable by one or more processors of an apparatus to cause the apparatus to further perform:
filtering the one or more sub-blocks with a 1D horizontal filter and one or more reference samples from a top reference row and/or one or more reference samples from a left reference column at a corresponding position.

25. The non-transitory computer readable medium of any one of clauses 21 to 24, wherein two or more filters are used for the parallel IPS process.

26. The non-transitory computer readable medium of clause 25, wherein the set of instructions that is executable by one or more processors of an apparatus to cause the apparatus to further perform:
selecting the two or more filters based on minimum rate-distortion cost by an encoder; and
signaling one or more flags to indicate the two or more filters.

27. The non-transitory computer readable medium of clause 25, wherein the two or more filters are selected based on a prediction mode.

28. The non-transitory computer readable medium of any one of clauses 21 to 27, wherein the prediction block includes less than 64 samples or more than 4096 samples.

29. The non-transitory computer readable medium of any one of clauses 21 to 28, wherein the set of instructions that is executable by one or more processors of an apparatus to cause the apparatus to further perform:
determining whether to perform the parallel IPS process based on a width and a height of the prediction block.

30. The non-transitory computer readable medium of any one of clauses 21 to 29, wherein the set of instructions that is executable by one or more processors of an apparatus to cause the apparatus to further perform:

performing the parallel IPS process on a chroma sample.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A video processing method, comprising:
dividing an intra prediction block into one or more sub-blocks;
performing padding process for the one or more sub-blocks; and
filtering the one or more sub-blocks with a parallel intra prediction smoothing (IPS) process.

2. The method of claim 1, wherein filtering the one or more sub-blocks with the parallel IPS process comprises:
filtering the one or more sub-blocks with a one-dimensional (1D) filter.

3. The method of claim 2, further comprising:
determining whether to filter with the 1D filter based on an intra prediction mode used for the prediction block.

4. The method of claim 2, further comprising:
filtering the one or more sub-blocks with a 1D horizontal filter and one or more reference samples from a top reference row and/or one or more reference samples from a left reference column at a corresponding position.

5. The method of claim 1, wherein two or more filters are used for the parallel IPS process.

6. The method of claim 5, further comprising:
selecting the two or more filters based on minimum rate-distortion cost by an encoder; and
signaling one or more flags to indicate the two or more filters.

7. The method of claim 5, wherein the two or more filters are selected based on a prediction mode.

8. An apparatus for video processing, the apparatus comprising:
a memory figured to store instructions; and
one or more processors configured to execute the instructions to cause the apparatus to perform:
dividing an intra prediction block into one or more sub-blocks;
performing padding process for the one or more sub-blocks; and
filtering the one or more sub-blocks with a parallel intra prediction smoothing (IPS) process.

9. The apparatus of claim 8, wherein the one or more processors are further configured to execute the instructions to cause the apparatus to perform:
filtering the one or more sub-blocks with a one-dimensional (1D) filter.

10. The apparatus of claim 9, wherein the one or more processors are further configured to execute the instructions to cause the apparatus to perform:
determining whether to filter with the 1D filter based on an intra prediction mode used for the prediction block.

11. The apparatus of claim 9, wherein the one or more processors are further configured to execute the instructions to cause the apparatus to perform:
filtering the one or more sub-blocks with a 1D horizontal filter and one or more reference samples from a top reference row and/or one or more reference samples from a left reference column at a corresponding position.

12. The apparatus of claim 8, wherein two or more filters are used for the parallel IPS process.

13. The apparatus of claim 12, wherein the one or more processors are further configured to execute the instructions to cause the apparatus to perform:
selecting the two or more filters based on minimum rate-distortion cost by an encoder; and
signaling one or more flags to indicate the two or more filters.

14. The apparatus of claim 12, wherein the two or more filters are selected based on a prediction mode.

15. A non-transitory computer readable medium that stores a set of instructions that is executable by one or more processors of an apparatus to cause the apparatus to initiate a method for video processing, the method comprising:
dividing an intra prediction block into one or more sub-blocks;
performing padding process for the one or more sub-blocks; and
filtering the one or more sub-blocks with a parallel intra prediction smoothing (IPS) process.

16. The non-transitory computer readable medium of claim 15, wherein the set of instructions that is executable by one or more processors of an apparatus to cause the apparatus to further perform:
filtering the one or more sub-blocks with a one-dimensional (1D) filter.

17. The non-transitory computer readable medium of claim 16, wherein the set of instructions that is executable by one or more processors of an apparatus to cause the apparatus to further perform:
determining whether to filter with the 1D filter based on an intra prediction mode used for the prediction block.

18. The non-transitory computer readable medium of claim 16, wherein the set of instructions that is executable by one or more processors of an apparatus to cause the apparatus to further perform:
filtering the one or more sub-blocks with a 1D horizontal filter and one or more reference samples from a top reference row and/or one or more reference samples from a left reference column at a corresponding position.

19. The non-transitory computer readable medium of claim 16, wherein two or more filters are used for the parallel IPS process.

20. The non-transitory computer readable medium of claim 19, wherein the set of instructions that is executable by one or more processors of an apparatus to cause the apparatus to further perform:
selecting the two or more filters based on minimum rate-distortion cost by an encoder; and
signaling one or more flags to indicate the two or more filters.

21. The non-transitory computer readable medium of claim 19, wherein the two or more filters are selected based on a prediction mode.
